(19) United States
(12) Patent Application Publication
(10) Pub. No.: US 2025/0234056 A1
(43) Pub. Date: Jul. 17, 2025

(54) TELEVISION-RELATED SETUP FOR A SMART HOME APPLICATION

(71) Applicant: Google LLC, Mountain View, CA (US)

(72) Inventor: Vasudha Gupta, Ghaziabad (IN)

(21) Appl. No.: 18/852,740

(22) PCT Filed: Sep. 27, 2023
(86) PCT No.: PCT/US2023/075249

§ 371 Date: Sep. 30, 2024

(51) Int. Cl. H04N 21/41; H04N 21/258; H04N 21/431; H04N 21/485

(52) U.S. Cl. CPC H04N 21/4122; H04N 21/25875; H04N 21/431; H04N 21/485

(57) ABSTRACT

According to an aspect, a method includes receiving, by a server computer, television setup criteria for a smart home application associated with an account of a user of the smart home application. The method may include receiving, by the server computer and from a network-enabled display device, a request to log into the account of the user, in response to logging into the account of the user, receiving a selection of the television setup criteria from the network-enabled display device; and in response to receiving the selection of the television setup criteria, facilitating an installation and use of at least one streaming service application on the network-enabled display device as specified by the television setup criteria, the television setup criteria being for a temporary mode of operation for the network-enabled display device.

### BACKGROUND

Users when traveling may want to view media content provided by a subscription-based streaming service on a network-enabled display device (e.g., a smart TV) located in an establishment that provides an accommodation for the traveler (e.g., a hotel room, a short-term rental property, etc.). Using conventional techniques, this may not be possible.

### SUMMARY

In some aspects, the techniques described herein relate to a method including: receiving, by a server computer, television setup criteria for a smart home application associated with an account of a user of the smart home application; receiving, by the server computer and from a network-enabled display device, a request to log into the account of the user; in response to logging into the account of the user, receiving a selection of the television setup criteria from the network-enabled display device; and in response to receiving the selection of the television setup criteria, facilitating an installation and use of at least one streaming service application on the network-enabled display device as specified by the television setup criteria, the television setup criteria being for a temporary mode of operation for the network-enabled display device.

In some aspects, the techniques described herein relate to a method, wherein the network-enabled display device is a first network-enabled display device; and wherein a television application for a casting device is associated with the user of the smart home application, the casting device being for a home mode of operation of a second network-enabled display device.

In some aspects, the techniques described herein relate to a method, wherein the temporary mode of operation for the first network-enabled display device is based on the first network-enabled display device being in a location of the user that is different from the location of the casting device.

In some aspects, the techniques described herein relate to a method, wherein the home mode of operation for the second network-enabled display device is based on the casting device being interfaced with the second network-enabled display device.

In some aspects, the techniques described herein relate to a method, wherein the casting device is in a home of the user and the location of the user is a travel accommodation.

In some aspects, the techniques described herein relate to a method, further including: receiving an indication that a mobile computing device of the user is located outside of a threshold distance from a location of the network-enabled display device; and based on receiving the indication, providing an alert to the mobile computing device, the alert being a reminder for the user to log out of the account of the user on the network-enabled display device.

In some aspects, the techniques described herein relate to a method, wherein the mobile computing device of the user includes the smart home application; and wherein the smart home application provides the indication and the reminder.

In some aspects, the techniques described herein relate to a method, further including based on facilitating the installation of the at least one streaming service application on the network-enabled display device, providing, to the smart home application, an identifier for the network-enabled display device.

In some aspects, the techniques described herein relate to a method, wherein the television setup criteria include, for each selected streaming service, credentials for a subscriber to a selected streaming service.

In some aspects, the techniques described herein relate to a method, wherein facilitating the installation of the at least one streaming service application on the network-enabled display device as specified by the television setup criteria includes: accessing a streaming service platform for a streaming service application of a selected streaming service: facilitating a downloading of the streaming service application from the streaming service platform to the network-enabled display device for installation on the network-enabled display device; and providing a deep link for the streaming service application installed on the network-enabled display device, the deep link for use with back end authentication when logging into the streaming service application on the network-enabled display device using the credentials for the subscriber to the selected streaming service included in the television setup criteria.

In some aspects, the techniques described herein relate to a non-transitory computer-readable medium storing executable instructions that when executed by at least one processor of a mobile computing device cause the at least one processor to execute operations, the operations including: rendering, by a smart home application executing on the mobile computing device, a user interface that provides a television setup option associated with an account of a user of the smart home application and a television application for a casting device; receiving, by the smart home application, television setup criteria for the television setup option; and providing, by the mobile computing device, the television setup criteria to a server computer for storage on the server computer for future use in facilitating use of the television setup criteria by a network-enabled display device accessible to the user and located in a temporary location of the user different from a location of the casting device.

In some aspects, the techniques described herein relate to a non-transitory computer-readable medium, wherein the operations further include: receiving an indication of the use of the television setup criteria by the network-enabled display device; and generating an entry in the smart home application identifying the network-enabled display device.

In some aspects, the techniques described herein relate to a non-transitory computer-readable medium, the operations further including: receiving a selection of the entry in the smart home application identifying the network-enabled display device; and displaying, in a user interface of the smart home application, an option to allow logging out of the account on the network-enabled display device.

In some aspects, the techniques described herein relate to a non-transitory computer-readable medium, wherein the operations further include: determining that the mobile computing device is located outside of a threshold distance from a location of the network-enabled display device; and based on determining that the mobile computing device is located outside of the threshold distance, displaying, on a display of the mobile computing device, a message reminding the user to log out of the account of the user on the network-enabled display device.

In some aspects, the techniques described herein relate to a non-transitory computer-readable medium, wherein displaying, on a display of the mobile computing device, the message reminding the user to log out of the account of the user on the network-enabled display device is further based on the operations including determining that the mobile computing device is located outside of the threshold distance from the location of the network-enabled display device for a period of time that meets or exceeds a predetermined timeframe.

In some aspects, the techniques described herein relate to a non-transitory computer-readable medium, wherein the operations further include generating, by the smart home application, the message reminding the user to log out of the account of the user on the network-enabled display device.

In some aspects, the techniques described herein relate to a non-transitory computer-readable medium, wherein determining that the mobile computing device of the user is located outside of the threshold distance is based on global positioning system (GPS) coordinates associated with the mobile computing device and the network-enabled display device.

In some aspects, the techniques described herein relate to a non-transitory computer-readable medium, wherein the network-enabled display device is a first network-enabled display device; wherein the temporary location of the user is a travel accommodation, and the television setup criteria is for a temporary mode of operation for the first network-enabled display device; and wherein a location of the casting device is a home of the user, and the casting device is interfaced with a second network-enabled display device for a home mode of operation for the second network-enabled display device.

In some aspects, the techniques described herein relate to a method including: rendering, by a smart home application executing on a mobile computing device, a user interface that provides a television setup option associated with an account of a user of the smart home application and a television application for a casting device; receiving, by the smart home application, television setup criteria for the television setup option; and providing, by the mobile computing device, the television setup criteria to a server computer for storage on the server computer for future use in facilitating use of the television setup criteria by a network-enabled display device accessible to the user and located in a temporary location of the user different from a location of the casting device.

In some aspects, the techniques described herein relate to a method, further including: receiving an indication of the use of the television setup criteria by the network-enabled display device; and generating an entry in the smart home application identifying the network-enabled display device.

In some aspects, the techniques described herein relate to a method, further including: receiving a selection of the entry in the smart home application identifying the network-enabled display device; and displaying, in a user interface of the smart home application, an option to allow logging out of the account on the network-enabled display device.

In some aspects, the techniques described herein relate to a method, further including: determining that the mobile computing device is located outside of a threshold distance from a location of the network-enabled display device; and based on determining that the mobile computing device is located outside of the threshold distance, displaying, on a display of the mobile computing device, a message reminding the user to log out of the account of the user on the network-enabled display device.

In some aspects, the techniques described herein relate to a method, wherein displaying, on a display of the mobile computing device, the message reminding the user to log out of the account of the user on the network-enabled display device further includes determining that the mobile computing device is located outside of the threshold distance from the location of the network-enabled display device for a period of time that meets or exceeds a predetermined timeframe.

In some aspects, the techniques described herein relate to a method, further including: generating, by the smart home application, the message reminding the user to log out of the account of the user on the network-enabled display device.

In some aspects, the techniques described herein relate to a method, wherein determining that the mobile computing device of the user is located outside of the threshold distance is based on global positioning system (GPS) coordinates associated with the mobile computing device and the network-enabled display device.

In some aspects, the techniques described herein relate to a method, wherein the network-enabled display device is a first network-enabled display device; wherein the temporary location of the user is a travel accommodation, and the television setup criteria is for a temporary mode of operation for the first network-enabled display device; and wherein a location of the casting device is a home of the user, and the casting device is interfaced with a second network-enabled display device for a home mode of operation for the second network-enabled display device.

In some aspects, the techniques described herein relate to a system including: at least one processor; and a non-transitory computer-readable medium storing executable instructions that execute a streaming service interface application on a server, the streaming service interface application configured to: receive, by a server computer, television setup criteria for a smart home application associated with an account of a user of the smart home application: receive, by the server computer and from a network-enabled display device, a request to log into the account of the user; in response to logging into the account of the user, receive a selection of the television setup criteria from the network-enabled display device; and in response to receiving the selection of the television setup criteria, facilitate a temporary installation and use of at least one streaming service application on the network-enabled display device as specified by the television setup criteria, the television setup criteria being for a temporary mode of operation for the network-enabled display device.

In some aspects, the techniques described herein relate to a system, wherein the network-enabled display device is a first network-enabled display device; and wherein a television application for a casting device is associated with the user of the smart home application, the casting device being for a home mode of operation of a second network-enabled display device.

In some aspects, the techniques described herein relate to a system, wherein the temporary mode of operation for the first network-enabled display device is based on the first network-enabled display device being in a location of the user that is different from the location of the casting device.

In some aspects, the techniques described herein relate to a system, wherein the home mode of operation for the second network-enabled display device is based on the casting device being interfaced with the second network-enabled display device.

The details of one or more implementations are set forth in the accompanying drawings and the description below. Other features will be apparent from the description and drawings, and from the claims.

### BRIEF DESCRIPTION OF THE DRAWINGS

FIG. 1A illustrates an example of a user interacting with a network-connected display device and a media adapter, according to implementations described throughout this disclosure.

FIG. 1B illustrates an example of a user interacting with a network-enabled display device in a location different from a location of a television adapter, according to implementations described throughout this disclosure.

FIG. 1C illustrates an example system for setting up a television (TV) setup option in a smart home application for subsequent use in facilitating a temporary installation and use of one or more streaming service applications on a network-enabled display device, according to implementations described throughout this disclosure.

FIGS. 2A-F illustrate example user interfaces for interacting with a smart home application on a mobile computing device to set up a new device in the smart home application according to implementations described throughout this disclosure.

FIGS. 3A-J illustrate example user interfaces for interacting with a network-enabled display device according to implementations described throughout this disclosure.

FIGS. 4A-C illustrate example user interfaces for interacting with a smart home application to manage a device in the smart home application according to implementations described throughout this disclosure.

FIG. 5 illustrates an example user interface for logging out of and deleting an account of the user on a network-enabled display device according to implementations described throughout this disclosure.

FIG. 6 illustrates a flowchart depicting example operations of the use of television setup criteria for a temporary mode of operation of a network-enabled display device.

FIG. 7 illustrates a flowchart depicting example operations of the setup of a television setup option for future use in a temporary mode of operation of a network-enabled display device.

FIG. 8 illustrates an example of a computer device and a mobile computing device, which may be used with the techniques described herein.

### DETAILED DESCRIPTION

A user may view media content while away from home. The user may view the media content on a network-enabled display device (e.g., a smart television (smart TV)) that may not be owned by the user. For example, the user may view media content provided by a subscription-based streaming service on a network-enabled display device located in a travel accommodation (e.g., a hotel room, a guest room in someone's home, a short-term rental property, etc.). The travel accommodation may be a temporary location for the user. It may be challenging, however, for the user to access and set up the individual applications for each of the subscription-based streaming services to view the media content on the network-enabled display device.

In some implementations, a user may travel with a media adapter. The media adapter, which may also be referred to as a casting device, can plug into or otherwise interface with a network-enabled display device to allow the user to play media content provided by subscription-based streaming services on the network-enabled display device. In these implementations, however, the user would need to remember to pack the media adapter. In addition, the user would need to plug in or otherwise interface the media adapter to the network-enabled display device located in a travel accommodation. This may be complicated because, for example, the user may find it difficult to access the connection on the network-enabled display device.

In some implementations, the user may download and set up each subscription-based streaming service application on a network-enabled display device. The setup may include entering personal subscription information for the user, which includes but is not limited to, a user identification, a password, and/or an email address. The user may perform the setup for each subscription-based streaming service application. The user may not be comfortable entering the personal subscription information of the user on a network-enabled display device that may be used by other people who stay or who have stayed in the travel accommodation. In particular, concerns regarding data security may be pertinent to entry of data in this way.

Users may typically travel with a multitude of mobile computing devices such as, for example, a smartphone, a tablet, a laptop, an eReader, etc. making the media adapter one more device to pack. In some implementations, a user may not want to download each subscription-based streaming service application and then enter their personal subscription information for each application on a commonly used network-enabled display device. Such a process may be time-consuming, subject to error, and utilize computing resources inefficiently.

The disclosure relates to a home device application (e.g., a smart home application) that may include a network-enabled display device setup option (e.g., a television (TV) setup option). The home device application may be installed on a mobile computing device of a user. The TV setup option may allow the user the ability to set up and view media content provided by subscription-based streaming services on a network-enabled display device located in a travel accommodation. The user may configure the TV setup option at any time. In some implementations, the home device application may be installed, and the TV setup option configured or set up, on one or more of the mobile computing devices that the user travels with prior to the user traveling. In some implementations, the user may set up the TV setup option on one or more of the mobile computing devices of the user while the user is traveling and away from home.

The TV setup option may allow the user to enter television setup criteria for the home device application (e.g., a smart home application). The TV setup option may allow the user to select subscription-based streaming service applications of interest and to enter personal subscription information of the user for each subscription-based streaming service application, for example, prior to travel. The use of the home device application by the user to view media content provided by a subscription-based streaming service on a network-enabled display device located in a travel accommodation may eliminate having to travel with a media adapter. In addition, or in the alternative, the use of the home device application by the user to view media content provided by a subscription-based streaming service on a network-enabled display device located in a travel accommodation may eliminate the user having to download, install, and log into each individual subscription service on a commonly used network-enabled display device of the travel accommodation. As such, the television setup criteria included in the TV setup option may be for a temporary mode of operation of the network-enabled display device because the user may view media content provided by subscription-based streaming services on the network-enabled display device while they are located in the travel accommodation. In this way, implementations of the present disclosure may help to ensure data security and/or reduce the number of interactions required to set-up a network-enabled display device.

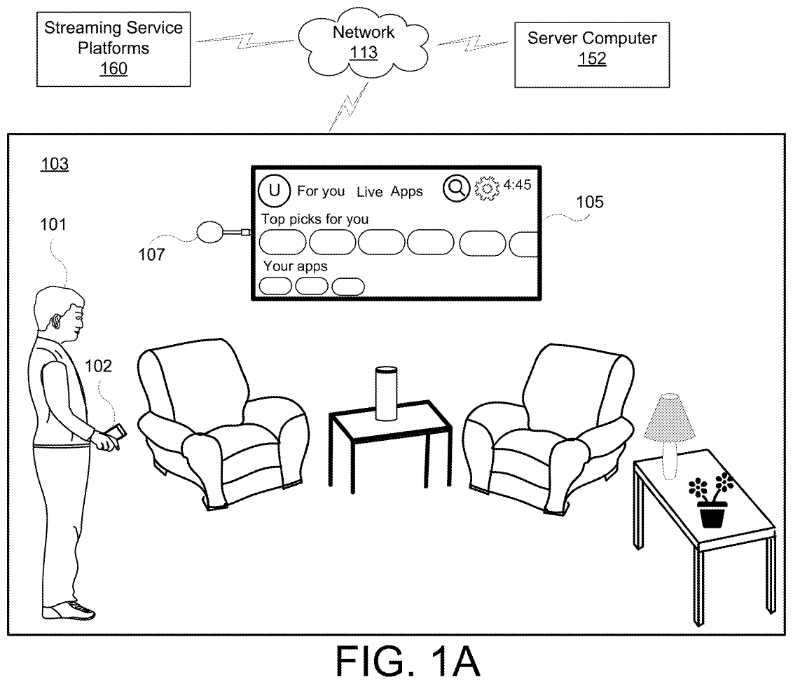

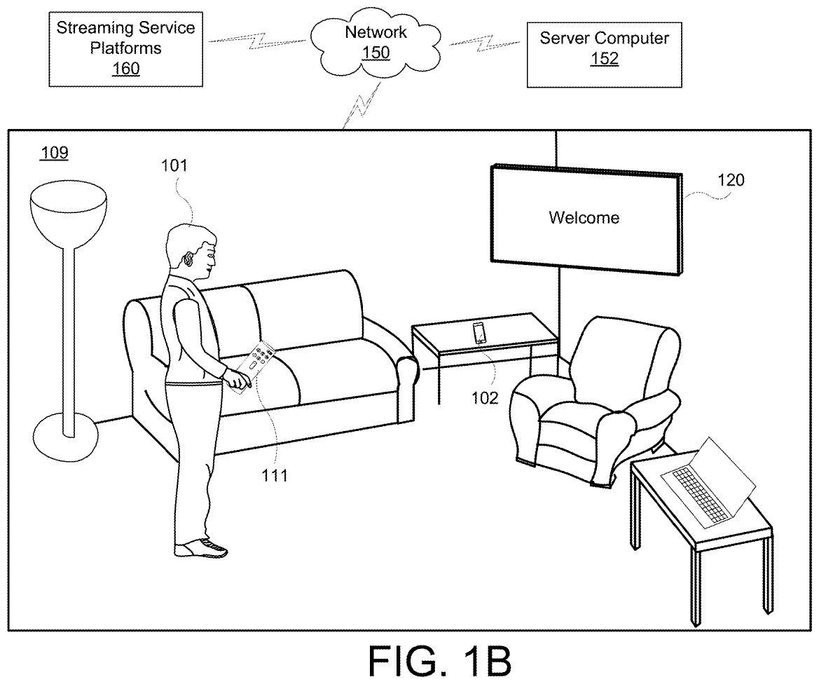

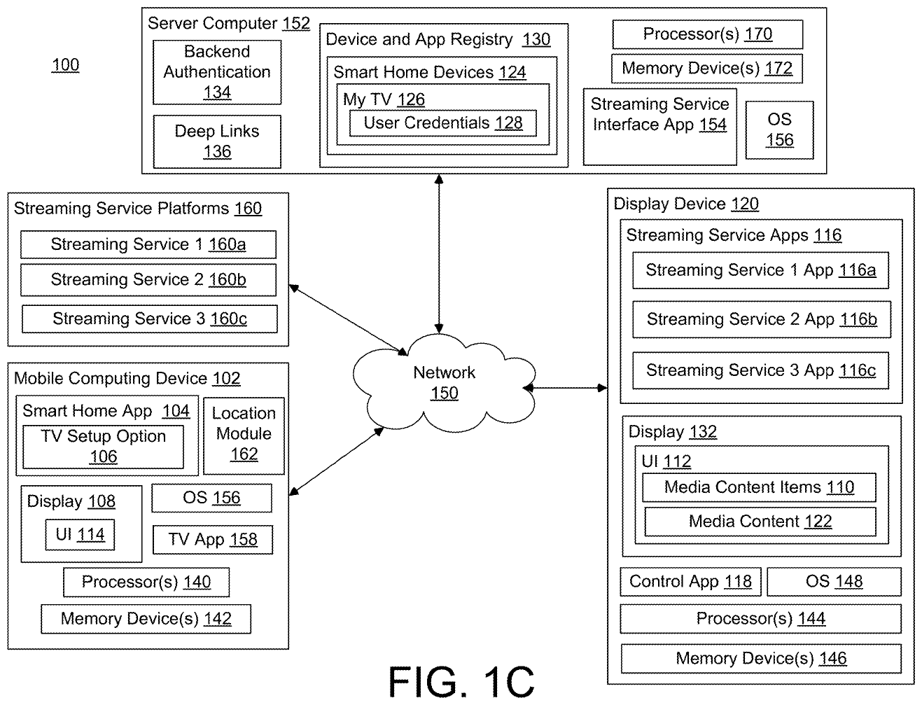

FIG. 1A illustrates an example of a user 101 located in a first environment 103 (e.g., a room in a home of the user). The user 101 is interacting with a network-enabled display device 105 and a media adapter 107. FIG. 1A will further be described with reference to FIG. 1C, which is described in more detail herein. For example, the user 101 may interact with a mobile computing device 102 when setting up a TV setup option 106 in a smart home application 104 installed on a mobile computing device 102. Examples of the mobile computing device 102 may include, but are not limited to, a mobile phone, a smartphone, a tablet computer, a laptop computer, and a personal digital assistant.

In some implementations, the first environment 103 may be an environment for a home mode of operation of the network-enabled display device 105. The first environment 103 may include the network-enabled display device 105 (e.g., a smart television). The network-enabled display device 105 may communicate with a server computer 152 and streaming service platforms 160 by way of a network 113. The streaming service platforms 160, the network-enabled display device 105, the server computer 152, and the mobile computing device 102 may interact with and communicate with one other by way of the network 113. In some implementations, the mobile computing device 102 may interface or connect to the media adapter 107 and/or the network-enabled display device 105 by way of a wireless communication link that may be a short-range wireless connection such as, for example a Bluetooth connection or a Wi-Fi (e.g., direct Wi-Fi) connection.

In some implementations, the media adapter 107 (e.g., a casting device, a media streaming device, a media streaming player) may be interfaced with or connected to the network-enabled display device 105. The media adapter 107 may interact with and communicate with the streaming service platforms 160, the server computer 152, and the mobile computing device 102 when providing media content to the network-enabled display device 105. In some implementations, the media adapter 107 may be embedded in and/or an integrated part of the network-enabled display device 105.

The media adapter 107 may facilitate providing (e.g., streaming) media content (e.g., streaming video such as movies, TV shows, etc.) from one or more streaming services included in the streaming service platforms 160 to the network-enabled display device 105. For example, the media adapter 107 may directly connect to a connector on the network-enabled display device 105 to provide digital video and/or audio to the network-enabled display device 105. For example, the media adapter 107 may connect to a high-definition multimedia interface (HDMI) connector included in the network-enabled display device 105. Examples of the media adapter 107 may include, but are not limited to, a set-top box, a television box, and a streaming media adapter.

The user 101 may connect to and interact with the media adapter 107 using a television (TV) application 158 installed on the mobile computing device 102. The user, interacting with the TV application 158, may select streaming services (e.g., free services, subscription-based services) for viewing media content on the network-enabled display device 105. As described, the media adapter 107 can facilitate the interface between the streaming service platforms 160 and the network-enabled display device 105 that the user 101 uses to view media content (e.g., streaming media content, movies, TV shows, etc.).

The user 101 may view media content provided by the streaming service platforms 160 while traveling away from home. Though it may be possible for the user 101 to view such media content on the mobile computing device 102, if available for use, the user 101 may prefer to view the media content on a larger-screen display device such as a network-enabled display device. In some implementations, the user may travel with the media adapter 107. The user 101 would unplug the media adapter 107 from the network-enabled display device 105 and then would pack the media adapter 107 (along with, for example, a power adapter and/or cables) for travel. This may be complicated and inconvenient for the user 101. It would therefore be beneficial if the user 101 could enjoy watching media content on a large-screen network-enabled display device, such as a smart TV, in a geographic location outside of the home of the user.

In addition, or in the alternative, the user 101 may view media content provided by the streaming service platforms 160 on another network-connected display device located in a different room or physical location in the home of the user. The user 101 could unplug the media adapter 107 from the network-enabled display device 105 and then plug it into or otherwise interface it with the other network-connected display device in the other room. This may be complicated and inconvenient for the user 101. It would therefore be beneficial if the user 101 could enjoy watching media content on another network-enabled display device such as a smart TV in another room of the home of the user.

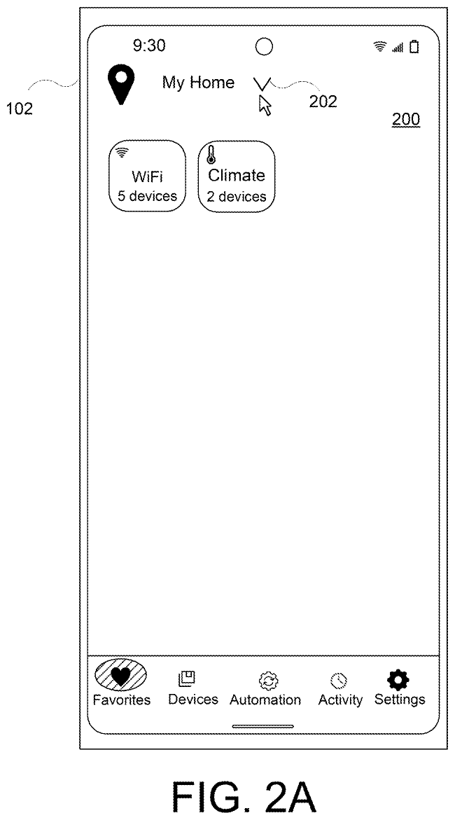

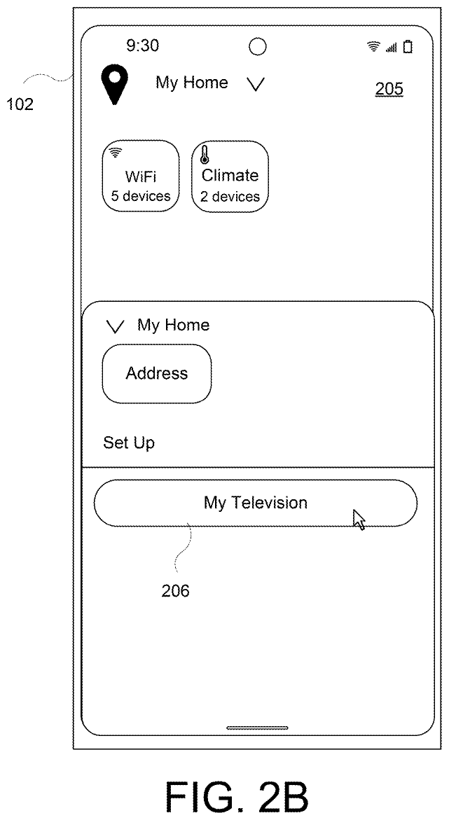

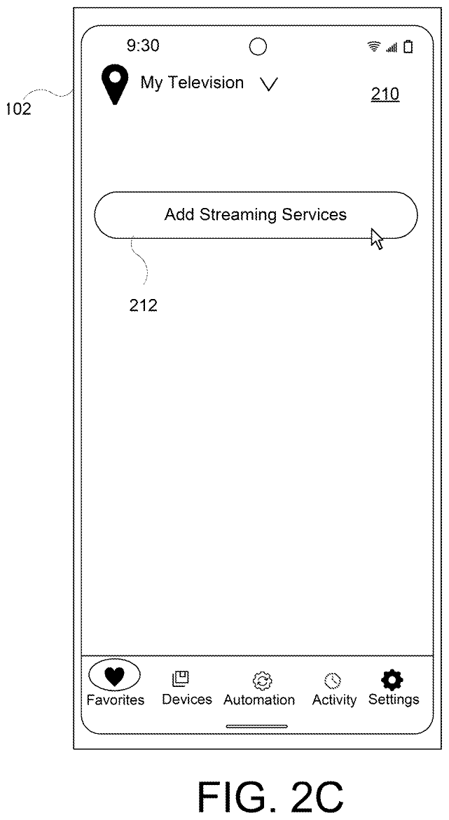

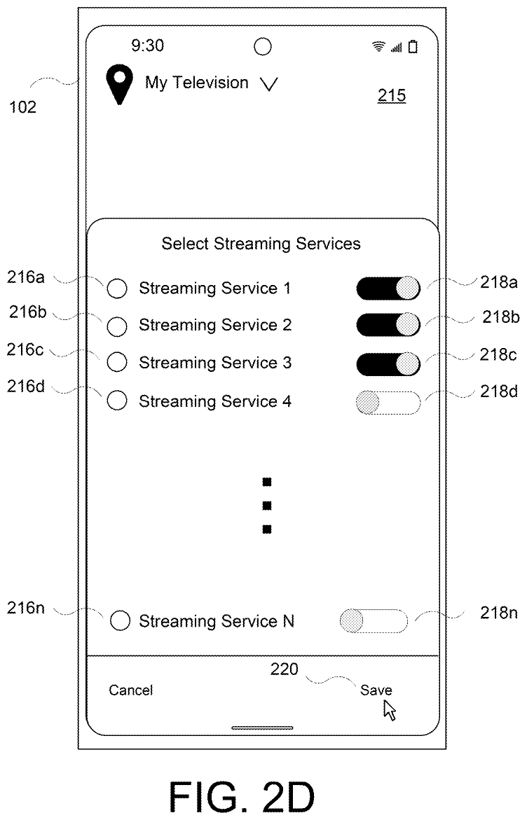

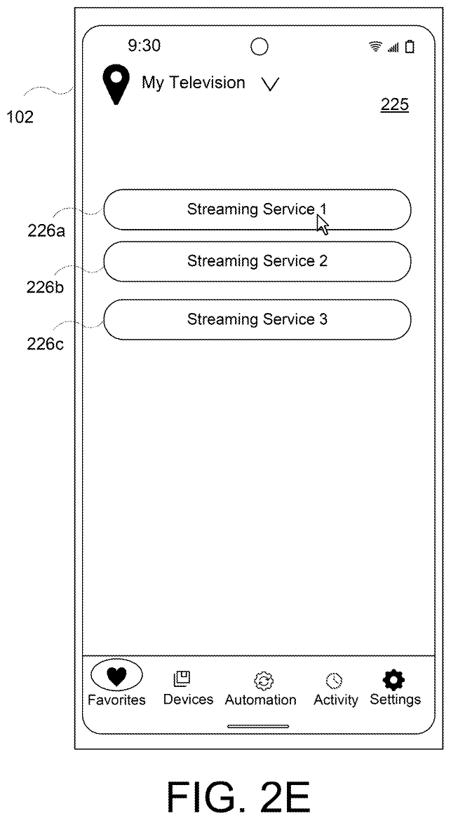

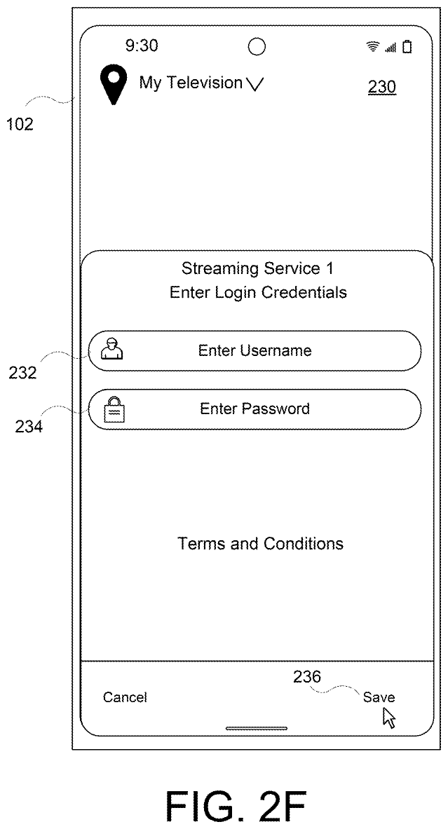

In some implementations, as described in more detail herein, the user 101 may configure the TV setup option 106 in the smart home application 104. As described in more detail with reference to FIGS. 2A-F, the smart home application 104 may render a user interface (UI) 114 for presenting on a mobile computing device display 108. The UI 114 for the smart home application 104 may guide the user 101 through the steps for selecting streaming services provided by the streaming service platforms 160. The user 101 may provide user credentials for a subscriber to any selected subscription-based streaming services. For example, the TV setup option 106 may be considered a setup for a “device” (e.g., a TV in the home of the user, a TV of a travel accommodation, etc.) associated with the smart home application 104. The TV setup option 106 may be associated with the account of the user of the smart home application 104. The TV setup option 106 may include information and credentials for a subscriber to one or more subscription-based streaming services whose native applications the user may want to have available on a network-enabled display device for use in viewing media content. In some implementations, the user 101 may set up the TV setup option 106 in the comfort of their home for future use, for example, while traveling. However, the user 101 may also set up the TV setup option 106 at any other time prior to its use, such as when the user 101 arrives at a travel accommodation.

FIG. 1B illustrates an example of a user (e.g., the user 101) interacting with a network-enabled display device 120 in a location (e.g., a second environment 109) different from a location of a media adapter (e.g., the media adapter 107). As described with reference to FIGS. 1A and 1C, in some implementations, the second environment 109 may be at a different geographic location than the first environment 103 (e.g., a travel accommodation). In some implementations, the second environment 109 may be in a different room than the first environment 103 (e.g., a different room of a house of the user).

In some implementations, the second environment 109 may be an environment for a temporary mode of operation of the network-enabled display device 120. The second environment 109 may include the network-enabled display device 120 (e.g., a smart television). The network-enabled display device 120 may communicate with the server computer 152 and the streaming service platforms 160 by way of a network 150. The streaming service platforms 160, the network-enabled display device 120, the server computer 152, and the mobile computing device 102 may interact with and communicate with one other by way of the network 150. The user 101 may interact with one or more applications executing on the network-enabled display device 120 using a remote control device 111.

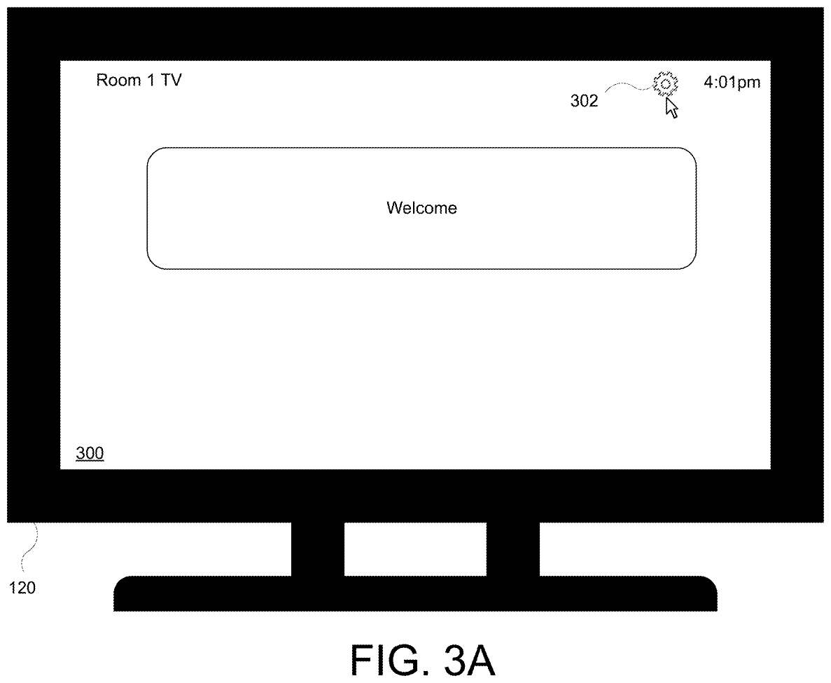

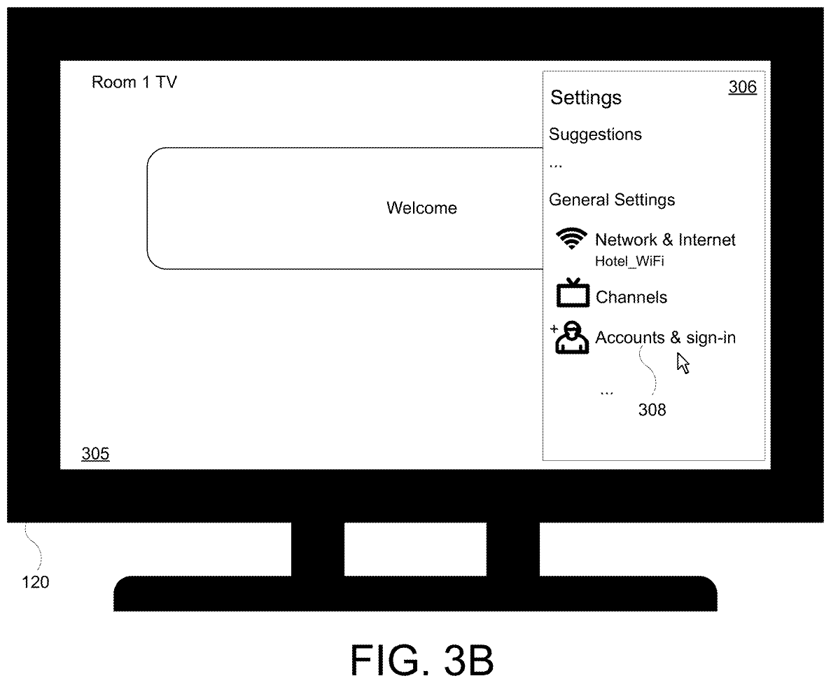

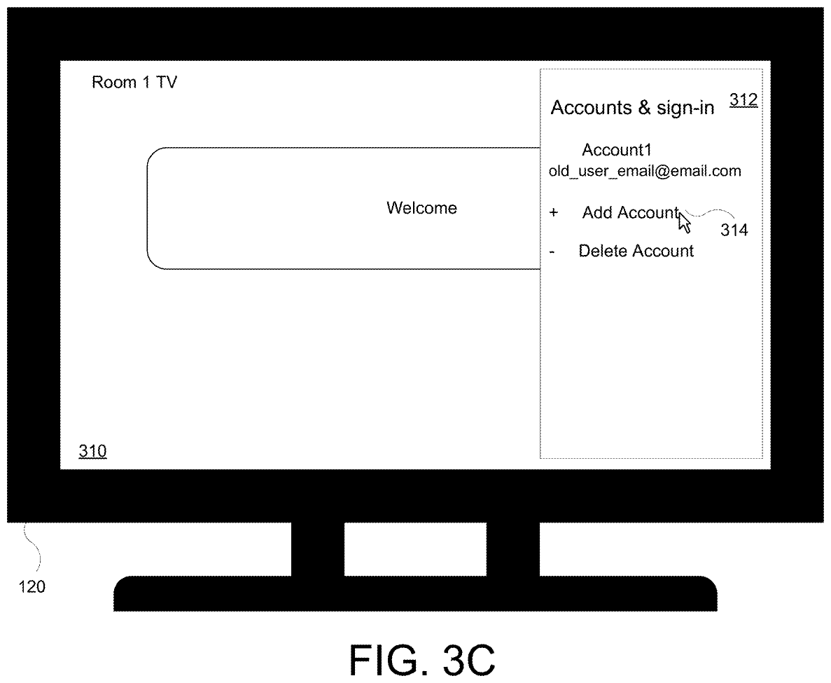

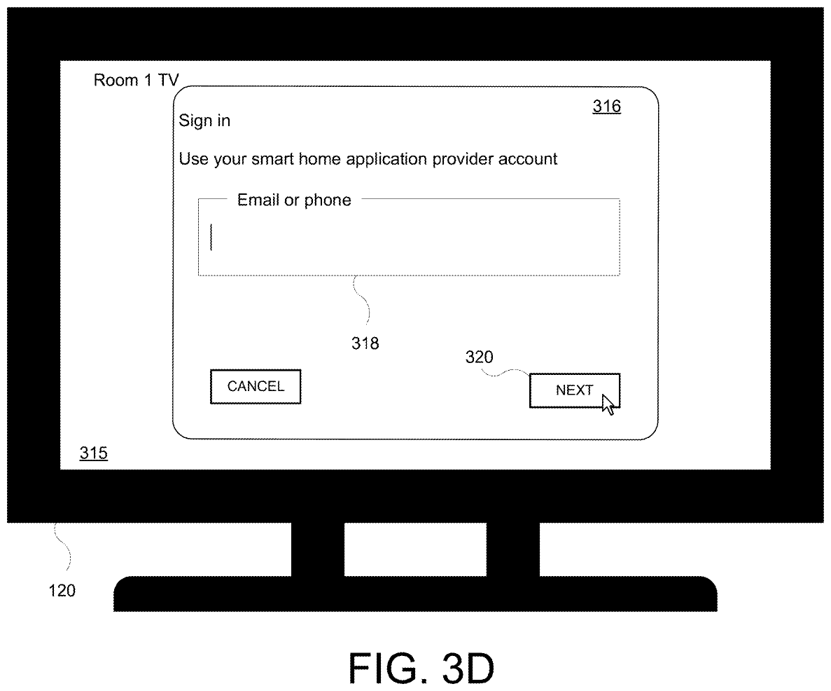

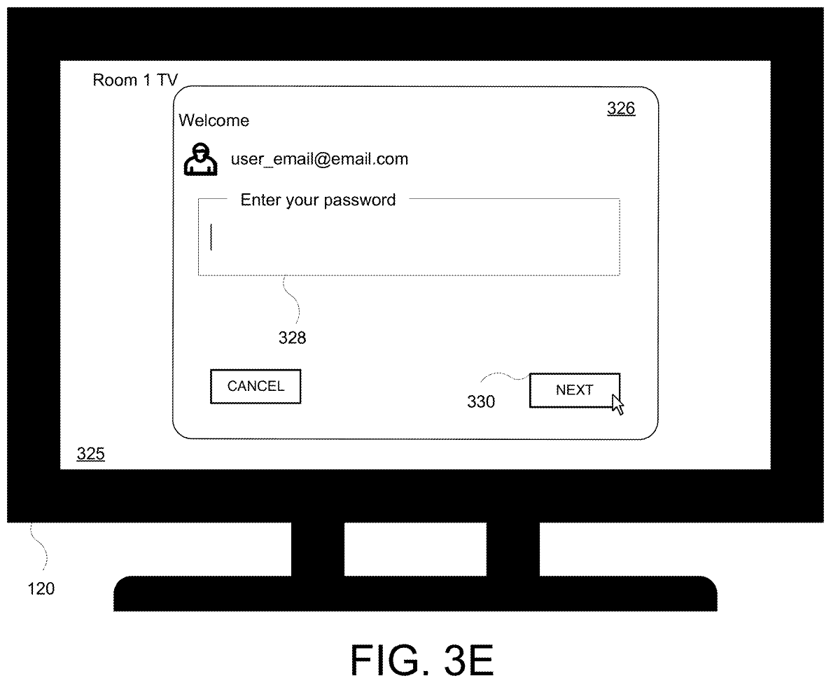

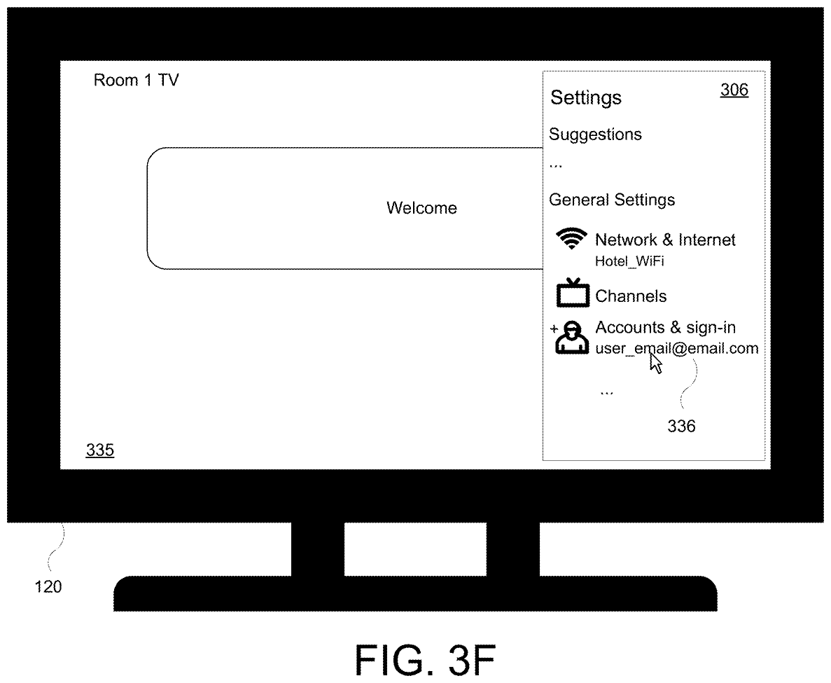

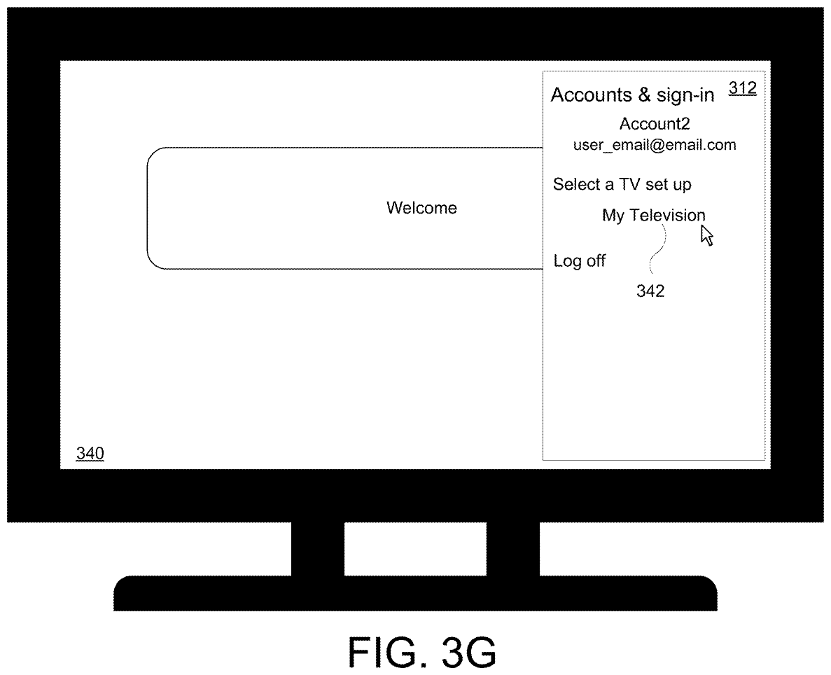

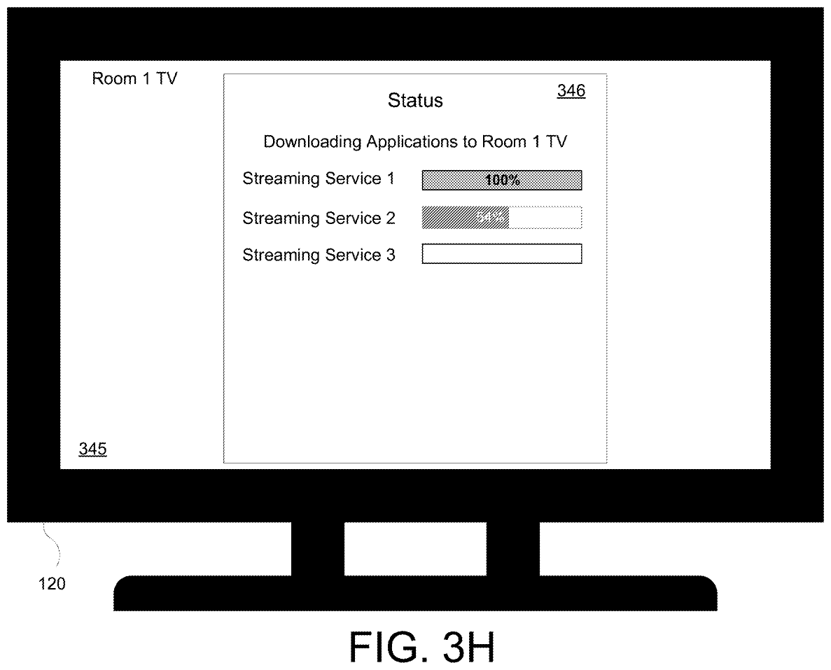

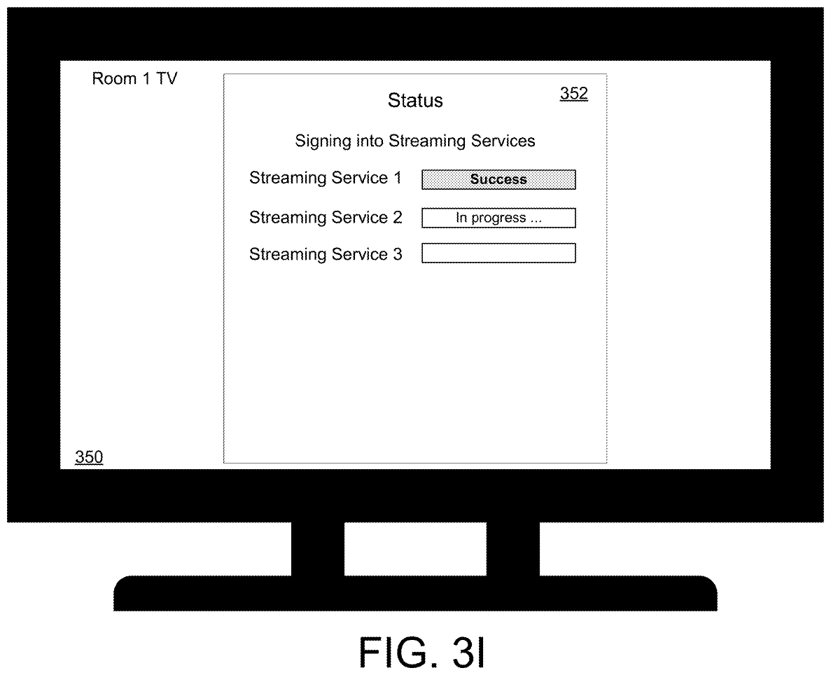

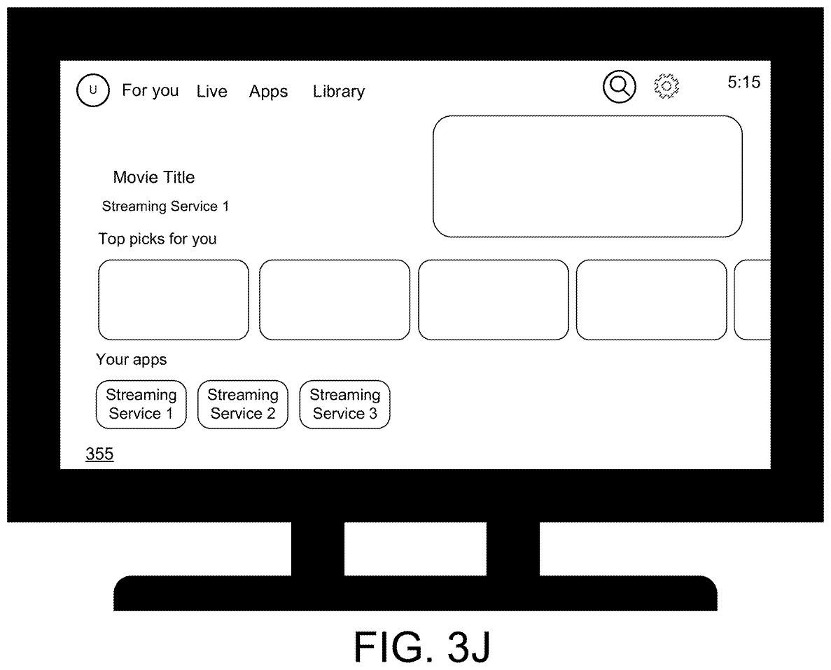

In some implementations, the second environment 109 may be a travel accommodation (e.g., a room in a hotel, a room in a short-term rental property, a room in a home of a friend or relative of the user, etc.). The user 101 may use the remote control device 111 to turn on the network-enabled display device 120. For example, a control application 118 on the network-enabled display device 120 may facilitate the connection of the network-enabled display device 120 to the server computer 152 by way of the network 150. With reference to FIGS. 1C and FIGS. 3A to 3J in which the interfacing with the network-enabled display device 120 will be described in further detail, the user 101 may interface with the control application 118 by selecting a settings icon 302 for a settings option, as shown in FIG. 3A, to log into a provider account of the user 101 that is associated with the smart home application 104 and hosted by the server computer 152.

Once logged into the provider account, the user 101 may interact with the control application 118 and select the My TV option 126 (e.g., my television option 342 as shown in FIG. 3G). Doing so enables the server computer 152 (and specifically a streaming service interface application 154 included in the server computer 152) to facilitate the downloading, installing, and logging into streaming service applications 116 on the network-enabled display device 120. Once completed, the network-enabled display device 120 may display an alternative location user interface screen 355 as shown in FIG. 3J on the network-enabled display device 120. The user 101 may then enjoy watching media content on the network-enabled display device 120. The user 101 may enjoy watching the media content on the network-enabled display device 120 without the complexity of having to travel with and/or connect the media adapter 107 to the network-enabled display device 120.

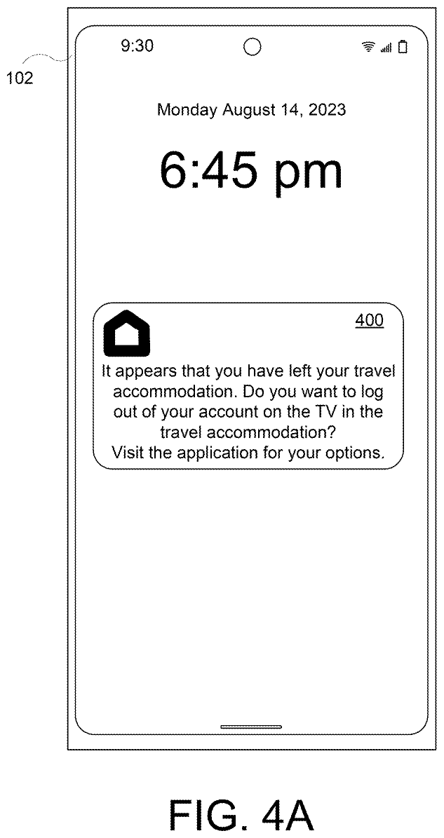

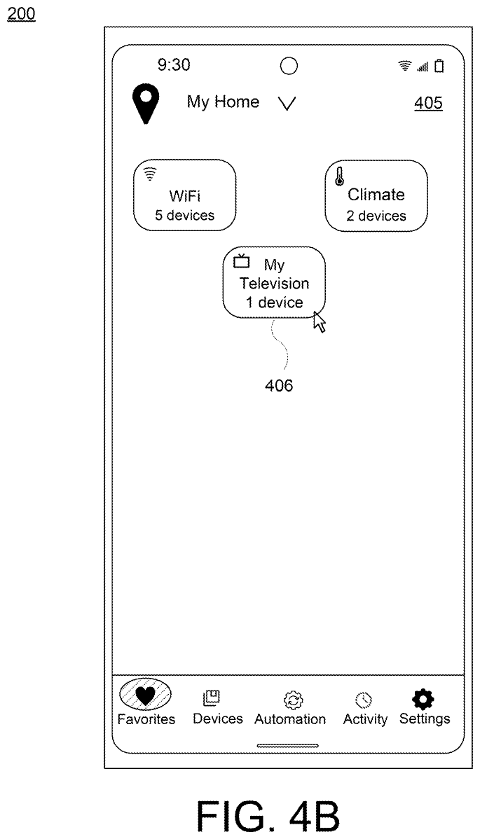

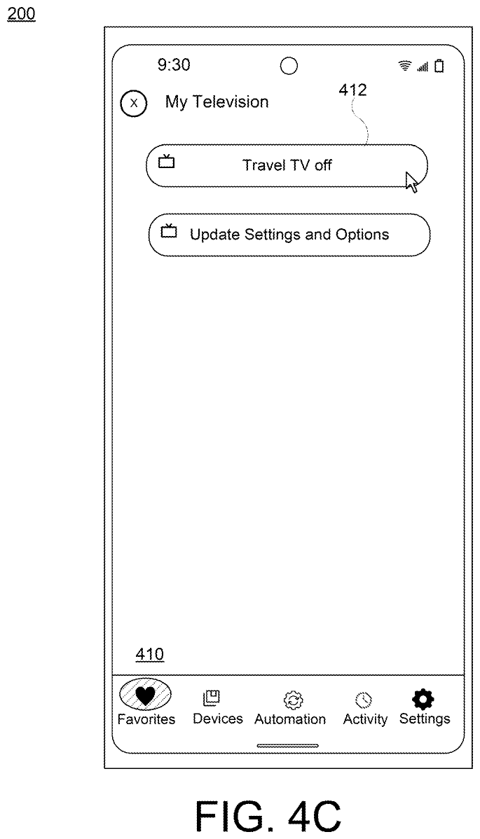

In some implementations, the downloading, installing, and logging into of the streaming service applications 116 on the network-enabled display device 120 may be temporary. For example, with reference to FIGS. 4A-C, the user 101 may receive an alert or message on the mobile computing device 102 when the mobile computing device 102 of the user is located at a geographic location greater than (outside of) a predetermined threshold distance from the location of the network-enabled display device 120. For example, determining that the mobile computing device 102 of the user is located outside of the threshold distance may be based on global positioning system (GPS) coordinates associated with the mobile computing device 102 and GPS coordinates associated with the network-enabled display device 120.

In some implementations, the alert may be based on the location of the mobile computing device 102 of the user relative to the network-enabled display device 120 as well as an amount of time that the mobile computing device 102 of the user is determined to be located at a geographic location greater than (outside of) a predetermined threshold distance from the location of the network-enabled display device 120. The alert may be a benefit that reminds the user 101 to log out of the account of the user 101 on the network-enabled display device 120 in implementations where the network-enabled display device 120 is in a travel accommodation and the user 101 is leaving or checking out of the travel accommodation.

FIG. 1C illustrates an example system 100 for setting up the TV setup option 106 in the smart home application 104 for subsequent use in facilitating a temporary installation and use of one or more streaming service applications (e.g., streaming service applications 116) on the network-enabled display device 120. The mobile computing device 102 may be configured to execute the smart home application 104. The mobile computing device 102 includes the mobile computing device display 108 configured to display the UI 114. A user may interact with the UI 114 to set up and control the smart home application 104. For example, the user may configure the TV setup option 106 in the smart home application 104.

The system 100 includes the network-enabled display device 120 configured to execute the control application 118. A user may interface with the control application 118 to log into and out of a provider account associated with the My TV option 126 of the smart home application 104. Once logged into the provider account, the user may select the TV setup option 106 associated with the account of the user (e.g., the My TV option 126). The TV setup option 106 may include information and credentials for a subscriber to one or more subscription-based streaming services whose native applications the user may want to have available on the network-enabled display device 120 for use in viewing media content on the display 132.

The server computer 152 may include a device and application registry (e.g., registry 130). The registry 130 may store information for one or more user accounts managed by the server computer 152. The registry 130 may store information for one or more user devices and/or applications associated with each of the one or more user accounts. For example, referring to FIGS. 1A and 1B, the registry 130 may store information for the media adapter 107, the network-enabled display device 120, the mobile computing device 102, the streaming service platforms 160, and the network-enabled display device 105. The registry 130 may store information for the television application 158, the streaming service applications 116, and the smart home application 104.

The system 100 includes the streaming service platforms 160. The streaming service platforms 160 may provide media content items (e.g., the media content items 110), media content (e.g., media content 122), and the streaming service applications 116 (e.g., streaming service 1 application 116a, streaming service 2 application 116b, streaming service 3 application 116c) to network-enabled display devices (e.g., the network-enabled display device 120, the network-enabled display device 105) for respective streaming services (e.g., streaming service 1 160a, streaming service 2 160b, streaming service 3 160c). The TV setup option 106 in the smart home application 104 may include a selection of subscription-based streaming services whose applications may be installed on the network-enabled display device 120. In some implementations, the streaming service platforms 160 may include subscription-based streaming services and/or no-fee based streaming services.

The network-enabled display device 120 may include one or more streaming service applications 116. Each of the streaming service applications 116 may be a native application for a subscription-based streaming service (e.g., streaming service 1 application 116a, streaming service 2 application 116b, streaming service 3 application 116c). In some implementations, in addition or in the alternative, one or more of the streaming service applications 116 may be for no-fee based streaming services.

Each native application (e.g., streaming service 1 application 116a, streaming service 2 application 116b, streaming service 3 application 116c) may provide streaming media content from a respective streaming service platform (e.g., streaming service 1 160a, streaming service 2 160b, streaming service 3 160c) to the network-enabled display device 120 for viewing on the display 132 (e.g., media content 122). In some implementations, the streaming service applications 116 may be downloaded to the network-enabled display device 120 by way of a network 150. The network-enabled display device 120 may display a user interface (UI) 112 on the display 132 that includes the media content items 110 for selection and further viewing by the user on the network-enabled display device 120. A user may execute a streaming service application on the network-enabled display device 120 to access and view media content items 110 and media content 122 on the display 132 of the network-enabled display device 120.

The system 100 includes one or more server computers (e.g., the server computer 152) configured to interface with the mobile computing device 102, the network-enabled display device 120, and the streaming service platforms 160 by way of the network 150. Referring to FIG. 1A, the server computer 152 is also configured to interface with the mobile computing device 102, the network-enabled display device 105, and the streaming service platforms 160 by way of the network 113.

In some implementations, the network 150 may establish a wireless communication link between the network-enabled display device 120, the mobile computing device 102, the server computer 152, and the streaming service platforms 160. In some implementations, referring to FIG. 1A, the network 113 may establish a wireless communication link between the network-enabled display device 105, the mobile computing device 102, the server computer 152, and the streaming service platforms 160. The server computer 152 is configured to execute the streaming service interface application 154. The streaming service interface application 154 may facilitate the interactions between the streaming service platforms 160, the network-enabled display device 120, and the network-enabled display device 105.

For example, the streaming service selections and information provided by the user when configuring the TV setup option 106 in the smart home application 104 may be uploaded and stored in the server computer 152 as the My TV option 126 included in smart home devices 124 for use by the smart home application 104 on the mobile computing device 102.

The streaming service interface application 154 may facilitate the downloading and enabling of the subscription-based streaming services selected by the user and stored in the TV setup option 106 of the smart home application 104. The streaming service interface application 154 may facilitate the interfacing of the network-enabled display device 120 with the streaming service platforms 160. In some implementations, the streaming service interface application 154 may facilitate the acquiring and downloading of each respective streaming services application to the network-enabled display device 120. In some implementations, in addition or in the alternative, the streaming service interface application 154 may facilitate the providing of login credentials for a subscriber to each streaming service application. For example, the user may enter their credentials for each selected streaming service (e.g., streaming service 1 160a, streaming service 2 160b, streaming service 3 160c) into the TV setup option 106 in the smart home application 104. The user may agree to store the user credentials in a user credentials repository 128 on the server computer 152.

The streaming service interface application 154 may interface with each streaming service (e.g., streaming service 1 160a, streaming service 2 160b, streaming service 3 160c) by way of the network 150. Each streaming service may provide a deep link to a deep links repository 136. The streaming service interface application 154 may access the deep links repository 136 and use a streaming service deep link and the user credentials for a subscriber for the streaming service along with backend authentication application 134 to log the user into the respective streaming service application on the network-enabled display device 120. Once logged into the streaming service application, the user may select media content items and view media content on the display 132 of the network-enabled display device 120.

For example, the streaming service interface application 154 may use the streaming service deep link for the streaming service 1 160a stored in the deep links repository 136, and the user credentials for the streaming service 1 160a stored in the user credentials repository 128 along with backend authentication application 134 to log the user into the streaming service 1 application 116a on the network-enabled display device 120. Once logged into the streaming service 1 application 116a, the user may then select media content items 110 and view media content 122 on the display 132 of the network-enabled display device 120.

The network-enabled display device 120 may be configured to connect to the network 150. In some implementations, the network-enabled display device 120 is a television (e.g., a smart television (TV)). The network-enabled display device 120 may include one or more processors (processor(s) 144), one or more memory devices (memory device(s) 146), and an operating system (OS) 148. The operating system 148 may execute (or assist with executing) the streaming service applications 116 and/or the control application 118.

In some implementations, the operating system 148 may be a browser application. A browser application is a web browser configured to access information on the Internet by way of a network (e.g., network 150). A browser application may launch one or more browser tabs in the context of one or more browser windows in the browser application. In some implementations, the operating system 148 is a Linux-based operating system configured to execute (or assist with executing) the streaming service applications 116 and/or the control application 118.

The mobile computing device 102 may be any type of computing device that includes one or more processors (processor(s) 140), one or more memory devices (memory device(s) 142), and an operating system 156. The mobile computing device 102 may be a smartphone, a tablet, a wearable device, a laptop computer, or a desktop computer. In some implementations, the operating system 156 may be system software that manages computer hardware, software resources, and provides common services for computing programs.

In some implementations, the mobile computing device 102 may be a tablet, a smartphone, or a wearable. In these implementations, the operating system 156 may be referred to as a mobile operating system. The mobile operating system may be configured to execute on devices that, in general, include display devices that may be smaller in size than, for example, a display device included in a laptop computer or a desktop computer. In some implementations, the mobile computing device 102 may be a laptop computer. In these implementations, the operating system may be referred to as a laptop or desktop operating system. In these implementations, the operating system 156 may be an operating system designed for a display that is larger in size than that included in a tablet, a smartphone, or a wearable.

The mobile computing device 102 may include the mobile computing device display 108. In some implementations, the mobile computing device display 108 is a display device such as a liquid crystal display (LCD), a light-emitting diode (LED) display, an organic light-emitting diode (OLED) display, or an active-matrix organic light-emitting diode (AMOLED) display. The network-enabled display device 120 may include the display 132. In some implementations, the display 132 is a display device such as a liquid crystal display (LCD), a light-emitting diode display (LED) display, a plasma display, a quantum dot light-emitting diode display (QLED) display, or an organic light-emitting diode (OLED) display.

The mobile computing device 102 may include a location module 162. The location module 162 may include software and/or hardware for use in determining a location of the mobile computing device 102. For example, the location module 162 may include a Global Positioning System (GPS) receiver that may provide location-related wireless data (e.g., GPS coordinates) to the server computer 152 by way of the network 150. The server computer 152 may use the location-related data to determine a location of the mobile computing device 102. In some implementations, the network-enabled display device 120 may provide location-related wireless data to the server computer 152 by way of the network 150 for use by the server computer 152 in determining a location of the network-enabled display device 120.

The server computer 152 may be computing devices that take the form of a number of different devices, for example a standard server, a group of such servers, or a rack server system. In some implementations, the server computer 152 may be a single system sharing components such as one or more processors (e.g., processor(s) 170) and one or more memory devices (e.g., memory device(s) 172).

The processor(s) 140, the processor(s) 144 and the processor(s) 170 may be formed in a substrate configured to execute one or more machine executable instructions or pieces of software, firmware, or a combination thereof. The processor(s) 140, the processor(s) 144 and the processor(s) 170 may be semiconductor-based. For example, the processor(s) 140, the processor(s) 144 and the processor(s) may include semiconductor material that can perform digital logic.

The memory device(s) 142, the memory device(s) 146, and the memory device(s) 172 may include main memory that stores information in a format that can be read and/or executed by the processor(s) 140, the processor(s) 144, and the processor(s) 170, respectively. The memory device(s) 142, the memory device(s) 146, and the memory device(s) 172 may include one or more random-access memory (RAM) devices and/or one or more read-only memory (ROM) devices.

The memory device(s) 142, the memory device(s) 146, and the memory device(s) 172 may store applications that, when executed by the processor(s) 140, the processor(s) 144, and the processor(s) 170, respectively, perform certain operations. For example, the memory device(s) 142 may store the operating system 156 and the smart home application 104 that, when executed by the processor(s) 140, may perform certain operations on the mobile computing device 102. For example, the memory device(s) 146 may store the operating system 148 and the control application 118 that, when executed by the processor(s) 144, may perform certain operations on the network-enabled display device 120.

In some implementations, in addition or in the alternative, the memory device(s) 172 may represent any kind of (or multiple kinds of) memory (e.g., RAM, flash, cache, disk, tape, etc.). In some implementations, the memory device(s) 172 may include external storage, e.g., memory physically remote from but accessible by the server computer 152. The server computer 152 may include one or more modules, engines, or applications representing specially programmed software. In some implementations, the server computer 152 may include the operating system 156, the backend authentication application 134, and the streaming service interface application 154. For example, the memory device(s) 172 may store the operating system 156, the backend authentication application 134, and the streaming service interface application 154 that, when executed by the processor(s) 170, may perform certain operations on server computer 152 to facilitate setting up the network-enabled display device 120 such that a user may view subscription-based streaming media content on the network-enabled display device 120.

The network 150 and the network 113 may include the Internet and/or other types of data networks, such as a local area network (LAN), a wide area network (WAN), a cellular network, satellite network, or other types of data networks. The network 150 and the network 113 may also include any number of computing devices (e.g., computer, servers, routers, network switches, etc.) that are configured to receive and/or transmit data within the network 150. The network 150 and the network 113 may further include any number of hardwired and/or wireless connections. The network 150 and the network 113 may be, for example, communications networks having one or more types of topologies, including but not limited to the Internet, intranets, local area networks (LANs), cellular networks, Ethernet, Storage Area Networks (SANs), telephone networks, and Bluetooth personal area networks (PAN). In some implementations, two or more devices in a sub-network may be coupled by way of a wired connection, while at least some of the devices in the same sub-network are coupled by way of a local radio communication network (e.g., ZigBee, Z-Wave, Insteon, Bluetooth, Wi-Fi and other radio communication networks).

FIGS. 2A-F illustrate example user interfaces for interacting with a smart home application on a mobile computing device, according to implementations described throughout this disclosure. FIGS. 2A-F are described with reference to FIGS. 1A-C.

Referring to FIG. 2A, in anon-limiting example, a user (e.g., the user 101) may launch the smart home application 104 on the mobile computing device 102 resulting in the displaying of a smart home application first user interface 200 for the smart home application 104. The user may select a first icon 202.

FIG. 2B illustrates an example smart home application second user interface 205 for the smart home application 104 that is displayed because the user selected the first icon 202. The smart home application second user interface 205 presents selectable buttons for set up options for additional devices to include in the smart home application 104. For example, the user may select a my television button 206. Selecting the my television button 206 begins a process for configuring the TV setup option 106 in the smart home application 104.

FIG. 2C illustrates an example smart home application third user interface 210 for the smart home application 104 that is displayed because the user selected the my television button 206. The smart home application third user interface 210 presents selectable buttons for items to include in the TV setup option 106 in the smart home application 104. For example, the user may select an add streaming services button 212. Selecting the add streaming services button 212 begins a process for adding selected streaming services to the TV setup option 106 in the smart home application 104.

FIG. 2D illustrates an example smart home application fourth user interface 215 for the smart home application 104 that is displayed because the user selected the add streaming services button 212. The smart home application fourth user interface 215 presents a list of streaming services 216a-n for selection by the user. For example, each of the streaming services 216a-n is associated with a respective sliding button of sliding buttons 218a-n that a user can control to select or deselect (not select) the associated streaming service. In the example shown in FIG. 2D, the user selected streaming service 1, streaming service 2, and streaming service 3. The user may then select a save option 220 to add or save the streaming service selections to the TV setup option 106.

FIG. 2E illustrates an example smart home application fifth user interface 225 for the smart home application 104 that is displayed because the user selected the save option 220 once the user completes selection of streaming services for including in the TV setup option 106. For example, the smart home application fifth user interface 225 displays streaming services buttons 226a-c. Each of the streaming services buttons 226a-c is associated with a respective streaming service selected by the user and included in the TV setup option 106 (e.g., streaming service 1, streaming service 2, and streaming service 3). The user may select each button of streaming services buttons 226a-c. A selection of a streaming services button will present the user with a user interface to facilitate the providing of login credentials for a subscriber to the selected streaming service.

FIG. 2F illustrates an example smart home application sixth user interface 230 for the smart home application 104 that is displayed because the user selected the streaming service 1 button 226a in the smart home application fifth user interface 225. The smart home application sixth user interface 230 includes a username entry field 232 and a password entry field 234. The user may enter a username and password for the selected streaming service, which in the example shown in FIG. 2F is streaming service 1. The user may select the save option 236. By selecting the save option 236, the smart home application 104 may facilitate the storage of the entered credentials for a subscriber to the streaming service 1 in the media content user credentials repository 128 for the My TV option 126 for the smart home devices 124 included in the registry 130 on the server computer 152. The user credentials may be available for use by the network-enabled display device 120 as described herein.

Though FIGS. 2E and 2F illustrate example user interfaces for entering credentials for a subscriber to the streaming service 1 selected by the user, the smart home application 104 may provide similar user interfaces for entering credentials for a subscriber to other user selected streaming services.

FIGS. 3A-J illustrate example user interfaces for interacting with a network-enabled display device, according to implementations described throughout this disclosure. FIGS. 3A-J are described with reference to FIGS. 1A-C.

Referring to FIG. 3A, a user may turn on a television in a location that is remote from the location of the media adapter 107. In a non-limiting example, a user (e.g., the user 101) may be in the second environment 109 and using the remote control device 111 may turn on the network-enabled display device 120. The network-enabled display device 120 may display a message or other text or graphic and a settings icon 302 in a first display screen 300. The user may select the settings icon 302.

FIG. 3B illustrates an example second display screen 305 for the network-enabled display device 120. The second display screen 305 includes a settings menu 306 that is displayed because the user selected the settings icon 302. The settings menu 306 includes selectable options for the user. In a non-limiting example, the user may select an accounts & sign-in option 308. Selecting the accounts & sign-in option 308 begins a process for adding and subsequently signing into an account for the user on the network-enabled display device 120.

FIG. 3C illustrates an example third display screen 310 for the network-enabled display device 120. The third display screen 310 includes an accounts & sign-in menu 312 that is displayed because the user selected the accounts & sign-in option 308. The accounts & sign-in menu 312 includes selectable options for the user. In a non-limiting example, the user may select an add account option 314. Selecting the add account option 314 begins a process for adding an account for the user on the network-enabled display device 120.

FIG. 3D illustrates an example fourth display screen 315 for the network-enabled display device 120. The fourth display screen 315 includes a network-enabled display device first user interface 316 that is displayed because the user selected the add account option 314. The first user interface 316 includes an account name entry field 318. The user may enter the username for the account the user wants to access on the network-enabled display device 120 in the account name entry field 318. Once complete, the user may select a next button 320.

FIG. 3E illustrates an example fifth display screen 325 for the network-enabled display device 120. The fifth display screen 325 includes a network-enabled display device second user interface 326 that is displayed because the user selected the next button 320. The second user interface 326 includes a password entry field 328. The user may enter the password for the account the user wants to access on the network-enabled display device 120 in the password entry field 328. Once complete, the user may select a next button 330.

FIG. 3F illustrates an example sixth display screen 335 for the network-enabled display device 120. The sixth display screen 335 includes an updated version of the settings menu 306 that includes the account of the user as an accounts & sign-in option 336 for selection by the user.

FIG. 3G illustrates an example seventh display screen 340 for the network-enabled display device 120. The seventh display screen 340 displays an updated accounts & sign-in menu 312 that provides a list of available TV set up options to the user for selection and use on the network-enabled display device 120. In a non-limiting example, the user may select the my television option 342 to begin the process of implementing the settings in the My TV option 126 on the network-enabled display device 120.

FIG. 3H illustrates an example eighth display screen 345 for the network-enabled display device 120. The eighth display screen 345 displays a progress menu 346 for the downloading and installation of the applications for the streaming services selected by the user and stored in the registry 130 as the My TV option 126 selected by the user for use on the network-enabled display device 120.

FIG. 3I illustrates an example ninth display screen 350 for the network-enabled display device 120. Once the installation of the selected streaming service applications is complete, the TV set up process for the network-enabled display device 120 then facilitates providing the user credentials provided by the user and stored in the registry 130 for the My TV option 126 to each respective streaming service whose application is installed on the network-enabled display device 120. The ninth display screen 350 displays a progress menu 352 for the sign-in process for each streaming service.

FIG. 3J illustrates an example alternative location user interface screen 355 for the network-enabled display device 120. Upon completion of the installation and successful sign-in to each streaming service on the network-enabled display device 120, the network-enabled display device 120 may display the alternative location user interface screen 355. The user may now select a streaming service application and begin watching media content on the network-enabled display device 120.

FIGS. 4A-C illustrate example user interfaces for interacting with a smart home application to manage a device in the smart home application according to implementations described throughout this disclosure. FIGS. 4A-C are described with reference to FIGS. 1A-C. In some implementations, the smart home application 104 may provide an alert to the user on the mobile computing device 102 of the user when the user is a particular distance from the network-enabled display device 120. For example, the smart home application 104 may determine location information for the mobile computing device 102 of the user and the network-enabled display device 120 using global positioning system (GPS) coordinates for the mobile computing device 102 and GPS coordinates for the network-enabled display device 120.

For example, the distance may be a threshold distance from the network-enabled display device 120 that, when the location of the user (the mobile computing device 102 of the user) exceeds, is greater than, or is outside of the threshold distance, triggers the smart home application 104 to provide an alert on the mobile computing device 102 of the user. For example, the threshold distance may be one mile from the network-enabled display device 120 so that if the user simply leaves their room to grab a coffee in the lobby and then returns to their room, the smart home application 104 may not provide an alert.

In some implementations, the smart home application 104 may base the alert on the location of the mobile computing device 102 of the user relative to the network-enabled display device 120 being greater than (outside of) a predetermined threshold distance from the location of the network-enabled display device 120, and on an amount of time that the mobile computing device 102 of the user is determined to be located at the geographic location greater than (outside of) the predetermined threshold distance from the location of the network-enabled display device 120. For example, if the threshold distance is one mile, the smart home application 104 may provide an alert if the mobile computing device 102 of the user is at a geographic location greater than (outside of) the predetermined threshold distance from the location of the network-enabled display device 120 for more than 24 hours. The alert can remind the user to log out of the TV application if they no longer require use of the TV application (e.g., they are checked out of the travel accommodation and did not just leave the travel accommodation for the day).

FIG. 4A illustrates an example notification message 400 displayed on the mobile computing device 102 of the user. For example, as described herein, a user may log into an account of the user on the network-enabled display device 120 to enjoy watching media content in a location other than the location of the media adapter 107. The notification message 400 may remind the user that they are logged into the account of the user on the network-enabled display device 120 when they are a predetermined distance from the location of the network-enabled display device 120. For example, the user may be at a geographic location one or more miles away from the geographic location of the network-enabled display device 120. In some situations, the user may just be traveling for the day and planning to return to the travel accommodation. In some implementations, the user may have checked out of the travel accommodation and forgot to log out of the account of the user on the network-enabled display device 120.

Referring to FIG. 4B, in a non-limiting example, a user (e.g., the user 101) may launch the smart home application 104 on the mobile computing device 102 resulting in the displaying of a smart home application updated first user interface 405 for the smart home application 104. The user may select a my television device 406 from a presented list of devices for the smart home application 104.

FIG. 4C illustrates an example smart home application seventh user interface 410 that displays a selectable option for remotely logging out of the account of the user on the network-enabled display device 120 (e.g., travel TV off option 412). Once selected, the smart home application 104 may facilitate the logging out of the account of the user on the network-enabled display device 120.

In some situations, the user may interact with one or more user interfaces provided by the network-enabled display device 120 to log out of the account of the user on the network-enabled display device 120. For example, referring to FIG. 2B, the second environment 109 may be at a different geographic location than the first environment 103 (e.g., a travel accommodation). The user may be checking out of the travel accommodation and may log out of the account of the user on the network-enabled display device 120 prior to leaving the travel accommodation. In another example, the second environment 109 may be in a different room than the first environment 103 (e.g., a different room of a house of the user). The user may no longer want to watch media content on the network-enabled display device 120 and may therefore log out of the account of the user on the network-enabled display device 120.

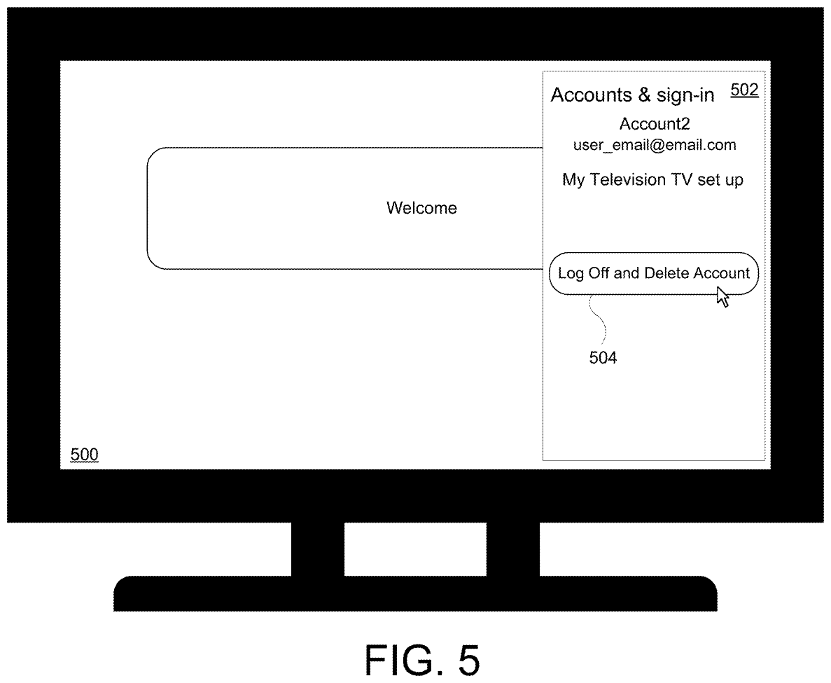

FIG. 5 illustrates an example user interface for logging out of and deleting an account of the user on a network-enabled display device according to implementations described throughout this disclosure. FIG. 5 is described with reference to FIGS. 1A-C and FIG. 3F.

Referring to FIG. 3F, the user may interact with the network-enabled display device 120 to display the example sixth display screen 335 that includes the settings menu 306. The settings menu 306 includes the account of the user as an accounts & sign-in option 336 for selection by the user.

Referring to FIG. 5, an example tenth display screen 500 for the network-enabled display device 120 includes an updated accounts & sign-in menu 502. The tenth display screen 500 is displayed because the user selected the accounts & sign-in option 336 from the settings menu 306. The updated accounts & sign-in menu 502 includes a log off and deleted account button. The user may select a log off and delete account button 504 if the user want to log out of the account of the user on the network-enabled display device 120 and delete the account of the user on the network-enabled display device 120. In general, a user may prefer to log out of and delete the account of the user when leaving a travel accommodation.

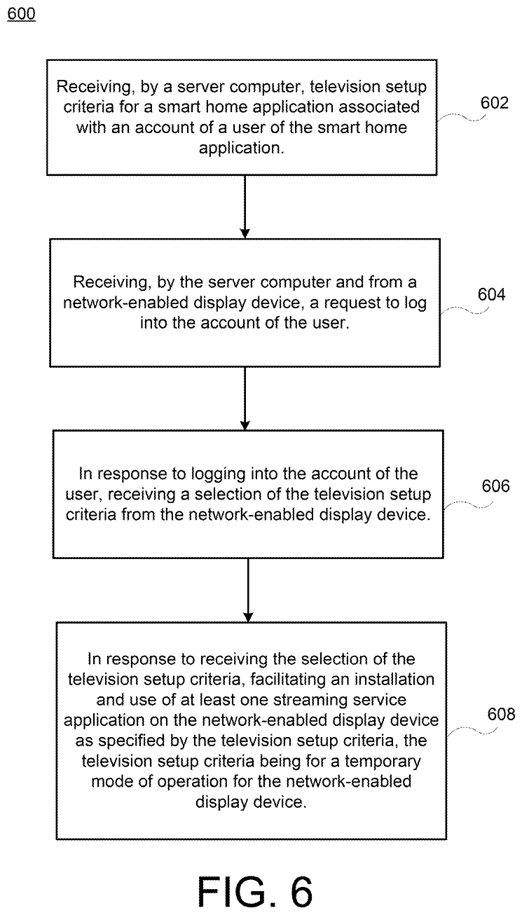

FIG. 6 illustrates a flowchart 600 depicting example operations of the use of television setup criteria for a temporary mode of operation of a network-enabled display device. Although the flowchart 600 of FIG. 6 illustrates the operations in sequential order, it will be appreciated that this is merely an example, and that additional or alternative operations may be included. Further, operations of FIG. 6 and related operations may be executed in a different order than that shown, or in a parallel or overlapping fashion. The operations may define a computer-implemented method. Although the flowchart 600 is described with reference to the system 100 of FIG. 1C, the flowchart 600 may be executed according to any of the figures discussed herein. In some examples, the operations of the flowchart 600 are executed by the server computer 152.

Operation 602 includes receiving, by a server computer, television setup criteria for a smart home application associated with an account of a user of the smart home application. For example, the server computer 152 may receive the TV setup option 106 that includes television setup criteria for the smart home application 104 associated with the user of the mobile computing device 102.

Operation 604 includes receiving, by the server computer and from a network-enabled display device, a request to log into the account of the user. For example, a user may interface with the control application 118 to log into an account of the user that is associated with the My TV option 126 of the smart home application 104.

Operation 606 includes, in response to logging into the account of the user, receiving a selection of the television setup criteria from the network-enabled display device. For example, once logged into the account, the user may select the TV setup option 106 associated with the account of the user (e.g., the My TV option 126). The TV setup option 106 may include television setup criteria that may include information and credentials for a subscriber to one or more subscription-based streaming services whose native applications the user may want to have available on the network-enabled display device 120 for use in viewing media content on the display 132.

Operation 608 includes, in response to receiving the selection of the television setup criteria, facilitating an installation and use of at least one streaming service application on the network-enabled display device as specified by the television setup criteria, the television setup criteria being for a temporary mode of operation for the network-enabled display device. For example, once logged into the account, the user 101 may interact with the control application 118 and select the My TV option 126 (e.g., my television option 342 as shown in FIG. 3G). Doing so enables the server computer 152 (and specifically a streaming service interface application 154 included in the server computer 152) to facilitate the downloading, installing, and logging into streaming service applications 116 on the network-enabled display device 120. Once completed, the network-enabled display device 120 may display an alternative location user interface screen 355 as shown in FIG. 3J on the network-enabled display device 120. The user 101 may then enjoy watching media content on the network-enabled display device 120 in a temporary mode of operation.

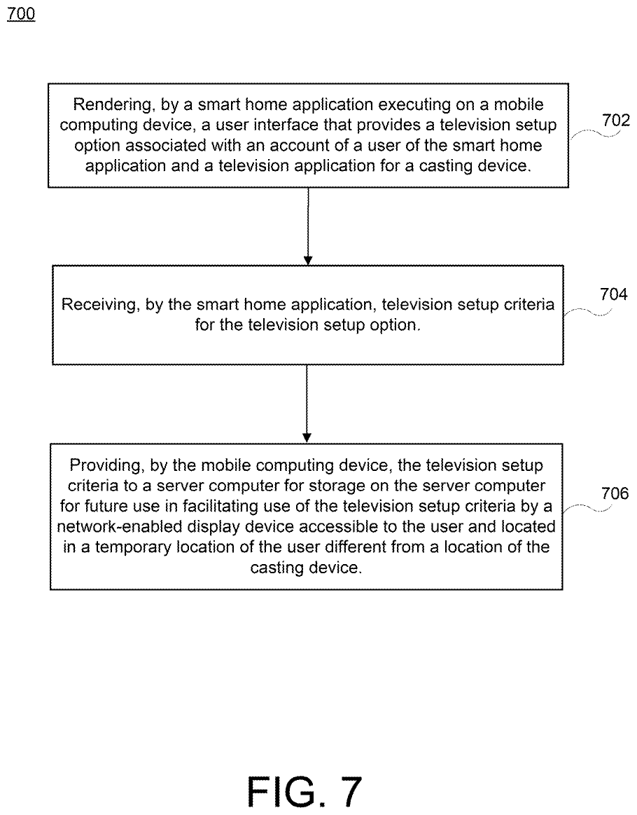

FIG. 7 illustrates a flowchart 700 depicting example operations of the use of television setup criteria for a temporary mode of operation of a network-enabled display device. Although the flowchart 700 of FIG. 7 illustrates the operations in sequential order, it will be appreciated that this is merely an example, and that additional or alternative operations may be included. Further, operations of FIG. 7 and related operations may be executed in a different order than that shown, or in a parallel or overlapping fashion. The operations may define a computer-implemented method. Although the flowchart 700 is described with reference to the system 100 of FIG. 1C, the flowchart 700 may be executed according to any of the figures discussed herein. In some examples, the operations of the flowchart 700 are executed by the server computer 152.

Operation 702 includes rendering, by a smart home application executing on a mobile computing device, a user interface that provides a television setup option associated with an account of a user of the smart home application and a television application for a casting device. For example, the smart home application 104 executing on a mobile computing device 102 may render a UI 114 on the mobile computing device display 108 that provides a TV setup option 106 with an account of a user of the smart home application 104 and the television application 158 for a casting device (e.g., the media adapter 107).

Operation 704 includes receiving, by the smart home application, television setup criteria for the television setup option. For example, the smart home application 104 may receive television setup criteria for the TV setup option 106.

Operation 706 includes, providing, by the mobile computing device, the television setup criteria to a server computer for storage on the server computer for future use in facilitating use of the television setup criteria by a network-enabled display device accessible to the user and located in a temporary location of the user different from a location of the casting device. For example, the mobile computing device 102 may provide the television setup criteria to the server computer 152 for storage in the registry 130 for future use in facilitating use of the television setup criteria by the network-enabled display device 120 accessible to the user and located in a temporary location of the user different from a location of the casting device.

In some examples, the techniques described herein relate to a method including: receiving, by a server computer, television setup criteria for a smart home application associated with an account of a user of the smart home application; receiving, by the server computer and from a network-enabled display device, a request to log into the account of the user; in response to logging into the account of the user, receiving a selection of the television setup criteria from the network-enabled display device; and in response to receiving the selection of the television setup criteria, facilitating an installation and use of at least one streaming service application on the network-enabled display device as specified by the television setup criteria, the television setup criteria being for a temporary mode of operation for the network-enabled display device.

In some examples, the techniques described herein relate to a method, wherein the network-enabled display device is a first network-enabled display device; and wherein a television application for a casting device is associated with the user of the smart home application, the casting device being for a home mode of operation of a second network-enabled display device.

In some examples, the techniques described herein relate to a method, wherein the temporary mode of operation for the first network-enabled display device is based on the first network-enabled display device being in a location of the user that is different from the location of the casting device.

In some examples, the techniques described herein relate to a method, wherein the home mode of operation for the second network-enabled display device is based on the casting device being interfaced with the second network-enabled display device.

In some examples, the techniques described herein relate to a method, wherein the casting device is in a home of the user and the location of the user is a travel accommodation.

In some examples, the techniques described herein relate to a method, further including: receiving an indication that a mobile computing device of the user is located outside of a threshold distance from a location of the network-enabled display device; and based on receiving the indication, providing an alert to the mobile computing device, the alert being a reminder for the user to log out of the account of the user on the network-enabled display device.

In some examples, the techniques described herein relate to a method, wherein the mobile computing device of the user includes the smart home application; and wherein the smart home application provides the indication and the reminder.

In some examples, the techniques described herein relate to a method, further including based on facilitating the installation of the at least one streaming service application on the network-enabled display device, providing, to the smart home application, an identifier for the network-enabled display device.

In some examples, the techniques described herein relate to a method, wherein the television setup criteria include, for each selected streaming service, credentials for a subscriber to a selected streaming service.

In some examples, the techniques described herein relate to a method, wherein facilitating the installation of the at least one streaming service application on the network-enabled display device as specified by the television setup criteria includes: accessing a streaming service platform for a streaming service application of a selected streaming service: facilitating a downloading of the streaming service application from the streaming service platform to the network-enabled display device for installation on the network-enabled display device; and providing a deep link for the streaming service application installed on the network-enabled display device, the deep link for use with back end authentication when logging into the streaming service application on the network-enabled display device using the credentials for the subscriber to the selected streaming service included in the television setup criteria.

In some examples, the techniques described herein relate to a non-transitory computer-readable medium storing executable instructions that when executed by at least one processor of a mobile computing device cause the at least one processor to execute operations, the operations including: rendering, by a smart home application executing on the mobile computing device, a user interface that provides a television setup option associated with an account of a user of the smart home application and a television application for a casting device; receiving, by the smart home application, television setup criteria for the television setup option; and providing, by the mobile computing device, the television setup criteria to a server computer for storage on the server computer for future use in facilitating use of the television setup criteria by a network-enabled display device accessible to the user and located in a temporary location of the user different from a location of the casting device.

In some examples, the techniques described herein relate to a non-transitory computer-readable medium, wherein the operations further include: receiving an indication of the use of the television setup criteria by the network-enabled display device; and generating an entry in the smart home application identifying the network-enabled display device.

In some examples, the techniques described herein relate to a non-transitory computer-readable medium, the operations further including: receiving a selection of the entry in the smart home application identifying the network-enabled display device; and displaying, in a user interface of the smart home application, an option to allow logging out of the account on the network-enabled display device.

In some examples, the techniques described herein relate to a non-transitory computer-readable medium, wherein the operations further include: determining that the mobile computing device is located outside of a threshold distance from a location of the network-enabled display device; and based on determining that the mobile computing device is located outside of the threshold distance, displaying, on a display of the mobile computing device, a message reminding the user to log out of the account of the user on the network-enabled display device.

In some examples, the techniques described herein relate to a non-transitory computer-readable medium, wherein displaying, on a display of the mobile computing device, the message reminding the user to log out of the account of the user on the network-enabled display device is further based on the operations including determining that the mobile computing device is located outside of the threshold distance from the location of the network-enabled display device for a period of time that meets or exceeds a predetermined timeframe.

In some examples, the techniques described herein relate to a non-transitory computer-readable medium, wherein the operations further include generating, by the smart home application, the message reminding the user to log out of the account of the user on the network-enabled display device.

In some examples, the techniques described herein relate to a non-transitory computer-readable medium, wherein determining that the mobile computing device of the user is located outside of the threshold distance is based on global positioning system (GPS) coordinates associated with the mobile computing device and the network-enabled display device.

In some examples, the techniques described herein relate to a non-transitory computer-readable medium, wherein the network-enabled display device is a first network-enabled display device: wherein the temporary location of the user is a travel accommodation and the television setup criteria is for a temporary mode of operation for the first network-enabled display device; and wherein a location of the casting device is a home of the user, and the casting device is interfaced with a second network-enabled display device for a home mode of operation for the second network-enabled display device.

In some examples, the techniques described herein relate to a system including: at least one processor; and a non-transitory computer-readable medium storing executable instructions that execute a streaming service interface application on a server, the streaming service interface application configured to: receive, by a server computer, television setup criteria for a smart home application associated with an account of a user of the smart home application; receive, by the server computer and from a network-enabled display device, a request to log into the account of the user; in response to logging into the account of the user, receive a selection of the television setup criteria from the network-enabled display device; and in response to receiving the selection of the television setup criteria, facilitate a temporary installation and use of at least one streaming service application on the network-enabled display device as specified by the television setup criteria, the television setup criteria being for a temporary mode of operation for the network-enabled display device.

In some examples, the techniques described herein relate to a system, wherein the network-enabled display device is a first network-enabled display device; and wherein a television application for a casting device is associated with the user of the smart home application, the casting device being for a home mode of operation of a second network-enabled display device.

In some examples, the techniques described herein relate to a system, wherein the temporary mode of operation for the first network-enabled display device is based on the first network-enabled display device being in a location of the user that is different from the location of the casting device.

In some examples, the techniques described herein relate to a system, wherein the home mode of operation for the second network-enabled display device is based on the casting device being interfaced with the second network-enabled display device.

In some examples, the techniques described herein relate to a method including: rendering, by a smart home application executing on a mobile computing device, a user interface that provides a television setup option associated with an account of a user of the smart home application and a television application for a casting device; receiving, by the smart home application, television setup criteria for the television setup option; and providing, by the mobile computing device, the television setup criteria to a server computer for storage on the server computer for future use in facilitating use of the television setup criteria by a network-enabled display device accessible to the user and located in a temporary location of the user different from a location of the casting device.

In some examples, the techniques described herein relate to a method, further including: receiving an indication of the use of the television setup criteria by the network-enabled display device; and generating an entry in the smart home application identifying the network-enabled display device.

In some examples, the techniques described herein relate to a method, further including: receiving a selection of the entry in the smart home application identifying the network-enabled display device; and displaying, in a user interface of the smart home application, an option to allow logging out of the account on the network-enabled display device.

In some examples, the techniques described herein relate to a method, further including: determining that the mobile computing device is located outside of a threshold distance from a location of the network-enabled display device; and based on determining that the mobile computing device is located outside of the threshold distance, displaying, on a display of the mobile computing device, a message reminding the user to log out of the account of the user on the network-enabled display device.

In some examples, the techniques described herein relate to a method, wherein displaying, on a display of the mobile computing device, the message reminding the user to log out of the account of the user on the network-enabled display device further includes determining that the mobile computing device is located outside of the threshold distance from the location of the network-enabled display device for a period of time that meets or exceeds a predetermined timeframe.

In some examples, the techniques described herein relate to a method, further including: generating, by the smart home application, the message reminding the user to log out of the account of the user on the network-enabled display device.

In some examples, the techniques described herein relate to a method, wherein determining that the mobile computing device of the user is located outside of the threshold distance is based on global positioning system (GPS) coordinates associated with the mobile computing device and the network-enabled display device.

In some examples, the techniques described herein relate to a method, wherein the network-enabled display device is a first network-enabled display device; wherein the temporary location of the user is a travel accommodation, and the television setup criteria is for a temporary mode of operation for the first network-enabled display device; and wherein a location of the casting device is a home of the user, and the casting device is interfaced with a second network-enabled display device for a home mode of operation for the second network-enabled display device.

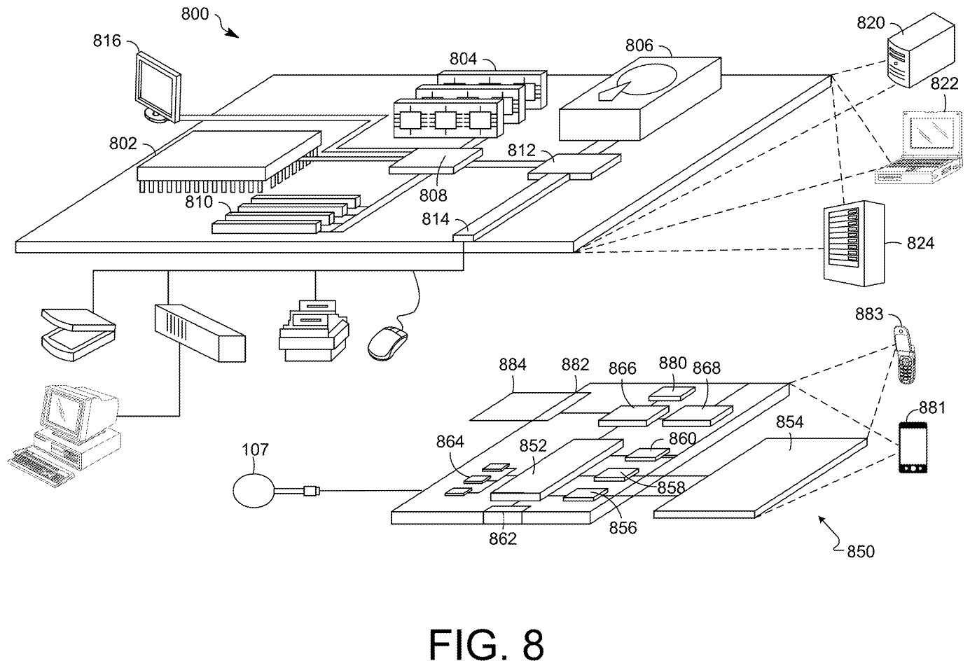

FIG. 8 shows an example of a computer device 800 and a mobile computer device 850, which may be used with the techniques described here. Computing device 800 is intended to represent various forms of digital computers, such as laptops, desktops, tablets, workstations, personal digital assistants, smart devices, appliances, electronic sensor-based devices, televisions, servers, blade servers, mainframes, and other appropriate computing devices. Computing device 850 is intended to represent various forms of mobile devices, such as personal digital assistants, cellular telephones, smart phones, and other similar computing devices. The components shown here, their connections and relationships, and their functions, are meant to be examples, and are not meant to limit implementations of the implementations described and/or claimed in this document.

Computing device 800 includes a processor 802, memory 804, a storage device 806, a high speed interface 808 connecting to memory 804 and high-speed expansion ports 810, and a low speed interface 812 connecting to low speed bus 814 and storage device 806. The processor 802 can be a semiconductor-based processor. The memory 804 can be a semiconductor-based memory. Each of the components 802, 804, 806, 808, 810, and 812, are interconnected using various busses, and may be mounted on a common motherboard or in other manners as appropriate. The processor 802 can process instructions for execution within the computing device 800, including instructions stored in the memory 804 or on the storage device 806 to display graphical information for a GUI on an external input/output device, such as display 816 coupled to high speed interface 808. In other implementations, multiple processors and/or multiple buses may be used, as appropriate, along with multiple memories and types of memory. Also, multiple computing devices may be connected, with each device providing portions of the operations (e.g., as a server bank, a group of blade servers, or a multi-processor system).

The memory 804 stores information within the computing device 800. In one implementation, the memory 804 is a volatile memory unit or units. In another implementation, the memory 804 is a non-volatile memory unit or units. The memory 804 may also be another form of computer-readable medium, such as a magnetic or optical disk. In general, the computer-readable medium may be a non-transitory computer-readable medium.

The storage device 806 is capable of providing mass storage for the computing device 800. In one implementation, the storage device 806 may be or contain a computer-readable medium, such as a floppy disk device, a hard disk device, an optical disk device, or a tape device, a flash memory or other similar solid state memory device, or an array of devices, including devices in a storage area network or other configurations. A computer program product can be tangibly embodied in an information carrier. The computer program product may also contain instructions that, when executed, perform one or more methods and/or computer-implemented methods, such as those described above. The information carrier is a computer- or machine-readable medium, such as the memory 804, the storage device 806, or memory on processor 802.

For example, the high speed interface 808 manages bandwidth-intensive operations for the computing device 800, while the low speed interface 812 manages lower bandwidth-intensive operations. In one implementation, the high speed interface 808 is coupled to memory 804, display 816 (e.g., through a graphics processor or accelerator), and to high-speed expansion ports 810, which may accept various expansion cards (not shown). In the implementation, low speed interface 812 is coupled to storage device 806 and low speed bus 814. The low-speed bus, which may include various communication ports (e.g., USB, Bluetooth, Ethernet, wireless Ethernet) may be coupled to one or more input/output devices, such as a keyboard, a pointing device, a scanner, or a networking device such as a switch or router. e.g., through a network adapter.

The computing device 800 may be implemented in a number of different forms, as shown in the figure. For example, it may be implemented as a standard server 820, or multiple times in a group of such servers. It may also be implemented as part of a rack server system 824. In addition, it may be implemented in a computer such as a laptop computer 822. Alternatively, components from computing device 800 may be combined with other components in a mobile device (not shown), such as device 850. Each of such devices may contain one or more of computing device 800, 850, and a system may be made up of multiple computing devices 800, 850 communicating with each other.

Computing device 850 includes a processor 852, memory 864, an input/output device such as a display 854, a communication interface 866, and a transceiver 868, among other components. The device 850 may also be provided with a storage device, such as a microdrive or other device, to provide additional storage. Each of the components 850, 852, 864, 854, 866, and 868, are interconnected using various buses, and several of the components may be mounted on a common motherboard or in other manners as appropriate.

The processor 852 can execute instructions within the computing device 850, including instructions stored in the memory 864. The processor may be implemented as a chipset of chips that include separate and multiple analog and digital processors. The processor may provide, for example, for coordination of the other components of the device 850, such as control of user interfaces, applications run by device 850, and wireless communication by device 850.

Processor 852 may communicate with a user through control interface 858 and display interface 856 coupled to a display 854. The display 854 may be, for example, a TFT LCD (Thin-Film-Transistor Liquid Crystal Display) or an OLED (Organic Light Emitting Diode) display, or other appropriate display technology. The display interface 856 may comprise appropriate circuitry for driving the display 854 to present graphical and other information to a user. The control interface 858 may receive commands from a user and convert them for submission to the processor 852. In addition, an external interface 862 may be provided in communication with processor 852, so as to enable near area communication of device 850 with other devices. External interface 862 may provide, for example, for wired communication in some implementations, or for wireless communication in other implementations, and multiple interfaces may also be used.

The memory 864 stores information within the computing device 850. The memory 864 can be implemented as one or more of a computer-readable medium or media, a volatile memory unit or units, or a non-volatile memory unit or units. Expansion memory 884 may also be provided and connected to device 850 through expansion interface 882, which may include, for example, a SIMM (Single In Line Memory Module) card interface. Such expansion memory 884 may provide extra storage space for device 850, or may also store applications or other information for device 850. Specifically, expansion memory 884 may include instructions to carry out or supplement the processes described above, and may include secure information also. Thus, for example, expansion memory 884 may be provided as a security module for device 850, and may be programmed with instructions that permit secure use of device 850. In addition, secure applications may be provided via the SIMM cards, along with additional information, such as placing identifying information on the SIMM card in a non-hackable manner.

The memory may include, for example, flash memory and/or NVRAM memory, as discussed below. In one implementation, a computer program product is tangibly embodied in an information carrier. The computer program product contains instructions that, when executed, perform one or more methods, such as those described above. The information carrier is a computer- or machine-readable medium, such as the memory 864, expansion memory 884, or memory on processor 852, that may be received, for example, over transceiver 868 or external interface 862.

Device 850 may communicate wirelessly through communication interface 866, which may include digital signal processing circuitry. Communication interface 866 may provide for communications under various modes or protocols, such as GSM voice calls, SMS, EMS, or MMS messaging, CDMA, TDMA, PDC, WCDMA, CDMA2000, or GPRS, among others. Such communication may occur, for example, through radio-frequency transceiver 868. In addition, short-range communication may occur, such as using a Bluetooth, low power Bluetooth, Wi-Fi, or other such transceiver (not shown). In addition, GPS (Global Positioning System) receiver module 880 may provide additional navigation- and location-related wireless data to device 850, which may be used as appropriate by applications running on device 850.

Device 850 may also communicate audibly using audio codec 860, which may receive spoken information from a user and convert it to usable digital information. Audio codec 860 may likewise generate audible sound for a user, such as through a speaker. e.g., in a handset of device 850. Such sound may include sound from voice telephone calls, may include recorded sound (e.g., voice messages, music files, etc.) and may also include sound generated by applications operating on device 850.

The computing device 850 may be implemented in a number of different forms, as shown in the figure. For example, it may be implemented as a cellular telephone 883. It may also be implemented as part of a smart phone 881, personal digital assistant, or other similar mobile device.

In some implementations, the computing device 850 may be placed within the media adapter 107 to create a system, for example, a casting device, a media streaming device, or a media streaming player that provides media content to the network-enabled display device 105 and/or to the network-enabled display device 120.

Various implementations of the systems and techniques described here can be realized in digital electronic circuitry, integrated circuitry, specially designed ASICs (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor and can be implemented in a high-level procedural and/or object-oriented programming language, and/or in assembly/machine language. As used herein, the terms “machine-readable medium” “computer-readable medium” refers to any computer program product, apparatus and/or device (e.g., magnetic discs, optical disks, memory, Programmable Logic Devices (PLDs)) used to provide machine instructions and/or data to a programmable processor, including a non-transitory machine-readable medium that receives machine instructions as a machine-readable signal. The term “machine-readable signal” refers to any signal used to provide machine instructions and/or data to a programmable processor.

To provide for interaction with a user, the systems and techniques described here can be implemented on a computer having a display device (e.g., a CRT (cathode ray tube) or LCD (liquid crystal display) monitor) for displaying information to the user and a keyboard and a pointing device (e.g., a mouse or a trackball) by which the user can provide input to the computer. Other kinds of devices can be used to provide for interaction with a user as well; for example, feedback provided to the user can be any form of sensory feedback (e.g., visual feedback, auditory feedback, or tactile feedback); and input from the user can be received in any form, including acoustic, speech, or tactile input.

The systems and techniques described here can be implemented in a computing system that includes a back end component (e.g., as a data server), or that includes a middleware component (e.g., an application server), or that includes a front end component (e.g., a client computer having a graphical user interface or a Web browser through which a user can interact with an implementation of the systems and techniques described here), or any combination of such back end, middleware, or front end components. The components of the system can be interconnected by any form or non-transitory medium of digital data communication (e.g., a communication network). Examples of communication networks include a local area network (“LAN”), a wide area network (“WAN”), and the Internet.

The computing system can include clients and servers. A client and server are generally remote from each other and typically interact through a communication network. The relationship of client and server arises by virtue of computer programs running on the respective computers and having a client-server relationship to each other.

In this specification and the appended claims, the singular forms “a,” “an” and “the” do not exclude the plural reference unless the context clearly dictates otherwise. Further, conjunctions such as “and,” “or,” and “and/or” are inclusive unless the context clearly dictates otherwise. For example, “A and/or B” includes A alone, B alone, and A with B. Further, connecting lines or connectors shown in the various figures presented are intended to represent example functional relationships and/or physical or logical couplings between the various elements. Many alternative or additional functional relationships, physical connections or logical connections may be present in a practical device.

Terms such as, but not limited to, approximately, substantially, generally, etc. are used herein to indicate that a precise value or range thereof is not required and need not be specified. As used herein, the terms discussed above will have ready and instant meaning to one of ordinary skill in the art.

Moreover, use of terms such as up, down, top, bottom, side, end, front, back, etc. herein are used with reference to a currently considered or illustrated orientation. If they are considered with respect to another orientation, it should be understood that such terms must be correspondingly modified.

Further, in this specification and the appended claims, the singular forms “a,” “an” and “the” do not exclude the plural reference unless the context clearly dictates otherwise. Moreover, conjunctions such as “and,” “or,” and “and/or” are inclusive unless the context clearly dictates otherwise. For example, “A and/or B” includes A alone, B alone, and A with B.

Although example methods, apparatuses and articles of manufacture have been described herein, the scope of coverage of this patent is not limited thereto. It is to be understood that terminology employed herein is for the purpose of describing particular aspects and is not intended to be limiting. On the contrary, this patent covers all methods, apparatus and articles of manufacture fairly falling within the scope of the claims of this patent.

Further to the descriptions above, a user may be provided with controls allowing the user to make an election as to both if and when systems, programs, or features described herein may enable collection of user information (e.g., a user's preferences, a user's current location, a user's credentials, etc.), and if the user is sent content or communications from a server. In addition, certain data may be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a user cannot be determined. Thus, the user may have control over what information is collected about the user, how that information is used, and what information is provided to the user.

1. A method comprising:
receiving, by a server computer, television setup criteria for a smart home application associated with an account of a user of the smart home application;
receiving, by the server computer and from a network-enabled display device, a request to log into the account of the user;
in response to logging into the account of the user, receiving a selection of the television setup criteria from the network-enabled display device; and
in response to receiving the selection of the television setup criteria, facilitating an installation and use of at least one streaming service application on the network-enabled display device as specified by the television setup criteria, the television setup criteria being for a temporary mode of operation for the network-enabled display device.

2. The method of claim 1,
wherein the network-enabled display device is a first network-enabled display device; and
wherein a television application for a casting device is associated with the user of the smart home application, the casting device being for a home mode of operation of a second network-enabled display device.

3. The method of claim 2, wherein the temporary mode of operation for the first network-enabled display device is based on the first network-enabled display device being in a location of the user that is different from the location of the casting device.

4. The method of claim 3, wherein the home mode of operation for the second network-enabled display device is based on the casting device being interfaced with the second network-enabled display device.

5. The method of claim 4, wherein the casting device is in a home of the user and the location of the user is a travel accommodation.

6. The method of claim 1, further comprising:
receiving an indication that a mobile computing device of the user is located outside of a threshold distance from a location of the network-enabled display device; and
based on receiving the indication, providing an alert to the mobile computing device, the alert being a reminder for the user to log out of the account of the user on the network-enabled display device.

7. The method of claim 6,
wherein the mobile computing device of the user includes the smart home application; and
wherein the smart home application provides the indication and the reminder.

8. The method of claim 7, further comprising based on facilitating the installation of the at least one streaming service application on the network-enabled display device, providing, to the smart home application, an identifier for the network-enabled display device.

9. The method of claim 1, wherein the television setup criteria include, for each selected streaming service, credentials for a subscriber to a selected streaming service.

10. The method of claim 9, wherein facilitating the installation of the at least one streaming service application on the network-enabled display device as specified by the television setup criteria comprises:
accessing a streaming service platform for a streaming service application of a selected streaming service;
facilitating a downloading of the streaming service application from the streaming service platform to the network-enabled display device for installation on the network-enabled display device; and
providing a deep link for the streaming service application installed on the network-enabled display device, the deep link for use with back end authentication when logging into the streaming service application on the network-enabled display device using the credentials for the subscriber to the selected streaming service included in the television setup criteria.

11.-18. (canceled)

19. A method comprising:
rendering, by a smart home application executing on a mobile computing device, a user interface that provides a television setup option associated with an account of a user of the smart home application and a television application for a casting device;
receiving, by the smart home application, television setup criteria for the television setup option; and
providing, by the mobile computing device, the television setup criteria to a server computer for storage on the server computer for future use in facilitating use of the television setup criteria by a network-enabled display device accessible to the user and located in a temporary location of the user different from a location of the casting device.

20. The method of claim 19, further comprising:
receiving an indication of the use of the television setup criteria by the network-enabled display device; and
generating an entry in the smart home application identifying the network-enabled display device.

21. The method of claim 20, further comprising:
receiving a selection of the entry in the smart home application identifying the network-enabled display device; and
displaying, in a user interface of the smart home application, an option to allow logging out of the account on the network-enabled display device.

22. The method of claim 19, further comprising:
determining that the mobile computing device is located outside of a threshold distance from a location of the network-enabled display device; and
based on determining that the mobile computing device is located outside of the threshold distance, displaying, on a display of the mobile computing device, a message reminding the user to log out of the account of the user on the network-enabled display device.

23. The method of claim 22, wherein displaying, on a display of the mobile computing device, the message reminding the user to log out of the account of the user on the network-enabled display device further comprises determining that the mobile computing device is located outside of the threshold distance from the location of the network-enabled display device for a period of time that meets or exceeds a predetermined timeframe.

24. The method of claim 22, further comprising: generating, by the smart home application, the message reminding the user to log out of the account of the user on the network-enabled display device.

25. The method of claim 22, wherein determining that the mobile computing device of the user is located outside of the threshold distance is based on global positioning system (GPS) coordinates associated with the mobile computing device and the network-enabled display device.

26. The method of claim 19,
wherein the network-enabled display device is a first network-enabled display device;
wherein the temporary location of the user is a travel accommodation, and the television setup criteria is for a temporary mode of operation for the first network-enabled display device; and
wherein a location of the casting device is a home of the user, and the casting device is interfaced with a second network-enabled display device for a home mode of operation for the second network-enabled display device.

27. A system comprising:
at least one processor; and
a non-transitory computer-readable medium storing executable instructions that execute a streaming service interface application on a server, the streaming service interface application configured to:
receive, by a server computer, television setup criteria for a smart home application associated with an account of a user of the smart home application;
receive, by the server computer and from a network-enabled display device, a request to log into the account of the user;
in response to logging into the account of the user, receive a selection of the television setup criteria from the network-enabled display device; and
in response to receiving the selection of the television setup criteria, facilitate a temporary installation and use of at least one streaming service application on the network-enabled display device as specified by the television setup criteria, the television setup criteria being for a temporary mode of operation for the network-enabled display device.

28.-33. (canceled)

34. A system comprising:
at least one processor; and
a non-transitory computer-readable medium storing executable instructions that execute a smart home application on a mobile computing device, the smart home application configured to:
render a user interface that provides a television setup option associated with an account of a user of the smart home application and a television application for a casting device;
receive television setup criteria for the television setup option; and
provide the television setup criteria to a server computer for storage on the server computer for future use in facilitating use of the television setup criteria by a network-enabled display device accessible to the user and located in a temporary location of the user different from a location of the casting device.
